(19) United States
(12) Patent Application Publication
(10) Pub. No.: US 2022/0308166 A1
(43) Pub. Date: Sep. 29, 2022

(54) SYSTEM AND METHOD FOR ELECTROMAGNETIC SIGNAL ESTIMATION

(71) Applicant: WISENSE TECHNOLOGIES LTD., Tel Aviv (IL)

(72) Inventors: Itai ORR, Tel Aviv (IL); Moshik Moshe COHEN, Or Yehuda (IL); Harel DAMARI, Tel Aviv (IL)

(73) Assignee: WISENSE TECHNOLOGIES LTD., Tel Aviv (IL)

(21) Appl. No.: 17/205,283

(22) Filed: Mar. 18, 2021

(51) Int. Cl. G01S 7/41; G01S 13/931; G01S 13/50; G01S 7/288; G06N 20/00; G06N 3/04

(52) U.S. Cl. CPC G01S 7/417; G01S 13/931; G01S 13/50; G01S 7/2883; G06N 20/00; G06N 3/04

(57) ABSTRACT

A system and method for improving a resolution of a system may include providing to the ML module a set of input electromagnetic signals from an array included in a system; and improving, by the ML module, the resolution of the system by generating and providing at least one additional electromagnetic signal, based on the received set.

### FIELD OF THE INVENTION

The present invention relates generally to estimating electromagnetic signals. More specifically, the present invention relates to increasing and/or improving resolution of systems that use electromagnetic signals, such as RADAR systems, by estimating, predicting and/or generating electromagnetic signals data based on input electromagnetic signals data.

### BACKGROUND OF THE INVENTION

Autonomous vehicles attract great attention in recent years due to their tremendous impact on the economy and society as well as their potential to save lives. The evolution from current driver assistance systems into autonomous vehicles requires several, functionally independent, sensing modalities for real time sensing and perception. The requirement for sensing redundancy spurred research toward more advanced camera and Light Detection and Ranging (LiDAR) based solutions. However, these sensing modalities suffer from inherent sensitivity to harsh weather and limited effective range, due to the electro-magnetic spectrum they utilize, 400-800 nm for cameras and 850-950 nm or 1.45-1.55 μm for LiDARs.

In contrast, automotive RADAR usually utilizes a frequency spectrum of 76-81 GHz, which offers robustness to weather conditions as well as longer effective range. However, utilization of RADAR for autonomous driving is hindered mainly due to the relatively low angular resolution currently provided by commercial platforms.

The angular resolution of a RADAR translates to the ability to distinguish and separate targets is described in formula 1 below:

Δθ ∝ 1/d Formula 1

where Δθ is angular resolution and d is the antenna diameter (physical aperture size). In automotive scenarios, where the environment is usually rich with objects and targets (e.g., in a cluttered environment), high angular resolution is critical. For example, two cars driving in adjacent lanes might be mis-detected due to a low angular resolution of a RADAR system, which may mis-detect them as a single target.

Formula 1 shows that larger antenna diameter corresponds to improved angular resolution. In a RADAR array (an array of radars in a system), the antenna elements are usually positioned about λ/2 apart from each other, with λ representing the central wavelength in free-space. Following this principle, an industry and academic trend has emerged to enlarge the physical aperture by increasing the number of physical transmitting and receiving channels. The drawbacks of this approach are complex system architecture prone to hardware failure, requirement for sensitive calibration process and high cost which hinder the adaptation of such systems in commercial applications.

An additional important factor affecting a RADAR's angular resolution is the algorithm used for beamforming. Fast Fourier Transform (FFT) performed on the angular dimensions of a RADAR array is considered a conventional beamformer and sets the Fourier resolution of a RADAR. Super-resolution methods aim to achieve sub-Fourier resolution. These include Estimation of Signal Parameters via Rotation Invariance Techniques (ESPRIT) or the popular Multiple Signal Classification (MUSIC). MUSIC's main disadvantages are a requirement of prior information on the number of targets, assumption on coexistent targets to be uncorrelated and high computation costs, which makes its usage in real-world automotive RADAR applications more challenging. In addition, most current super-resolution methods usually require using many snapshots (frames) in order to improve the estimation of the spatial covariance matrix. This requirement is highly problematic in safety critical automotive applications, since each added snapshot increases the reaction time of the system.

High resolution automotive RADAR sensors are required in order to meet the high bar of Advance Driver Assistance Systems (ADAS) and autonomous vehicles needs and regulations. An industry and academic trend to improve angular resolution by increasing the number of physical receiving channels suffers from a number of drawbacks, for example, increasing the number of physical receiving channels also increases system complexity, which is associated with high cost, requires sensitive calibration processes and lowers robustness to hardware malfunctions.

Recently, deep learning has begun to make an impact on traditional RADAR signal processing, perception and system design. RADAR data was used with deep neural networks (DNN) for road user classification, multi-class object classification, road user detection, vehicle detection, lane detection and semantic segmentation. Apart from perception tasks, DNNs have proven useful for cognitive antenna design in phased array RADAR and enhanced RADAR imaging. A DNN may generally be used to produce a model or a machine learning (ML) module. For example, by training a DNN to perform a task, a model or ML module may be developed such that the model or ML module is adapted to perform the task. Where applicable, the terms DNN and ML module may mean the same thing and may be used herein interchangeably.

Another family of algorithms in RADAR signal processing is Compressed Sensing (CS), which exploit sparseness in a scene to reconstruct one or more dimensions of a RADAR data cube (e.g., range-Doppler-azimuth-elevation). Complex Block Sparse Bayesian Learning (BSBL) was demonstrated for RADAR signal reconstruction. Examination of CS for Multiple In Multiple Out (MIMO) RADAR concluded that these techniques remain valid when there are under 106 scatter points in a scene. However, in typical urban scenes which may contain many more scatter points, these methods require a high minimum threshold in order to minimize the number of scatterers.

Research towards utilizing DNNs to improve RADAR angular resolution is in its early stages. RADAR data in range-Doppler representation was used with a Generative Adversarial Network (GAN) architecture to demonstrate super-resolution in two specific cases. The first is of pedestrians' micro-Doppler signature by collecting data of people walking on a treadmill, and the second is of a staircase which achieved angular super-resolution with a factor of 2×. However, these solutions suffer from a difficulty in assembling a large manually labeled dataset in real-world scenarios for the general case of numerous types of objects, classes, materials and shapes. In some cases, instead of real-world data, synthetic data was used for training with a single RADAR snapshot (i.e., single frame) as input. However, a drawback of using synthetic data for training before deployment in a real-world environment is degraded performance caused by modeling and numerical errors in the simulation used to create the synthetic data.

Multiple snapshots of a spatial covariance matrix were used with a Convolutional Neural Network (CNN) and a 1D antenna array with simulated data for Direction of Arrival (DOA) estimation and super-resolution. A single snapshot of a spatial covariance matrix was used with a fully connected model for DOA estimation and super resolution of a 2D antenna array with simulated data and a 1D antenna array with both simulation and real-world data where the targets were corner reflectors. Two snapshots were used with an anechoic chamber setup to generate a dataset which was used with a fully connected model for DOA estimation.

Although shown for simulated data or controlled scenarios with very few targets, known systems and studies show the potential that DNN have for super-resolving RADAR data in real-world environments which usually contain many targets and reflections, known methods for DNN-based RADAR super-resolution fail to be generalized, or adapted for, un-controlled, real-world environments mainly due to a lack of a suitable training methodology.

Self-supervised learning is a young research area and is considered a part of the unsupervised training family, where one part of a data is used to predict a different part of the same data. The strength and disruptive potential of this training methodology lies in the fact that, in many applications, data is in abundance. However, labeling data, which is essential for supervised training, is a time-consuming and an expensive process. Furthermore, in some applications, such as image denoising, manual labeling is not a viable solution. Self-supervised techniques showed promising early results for semantic image segmentation, temporal cycle-consistency to learn temporal alignment between videos, dense shape correspondence for 3D objects and feature representation for visual tasks.

The field of image super-resolution has also utilized self-supervision to create State-Of-The-Art (SOTA) result. At its fundamentals, self-supervision for image super-resolution uses a high-resolution image which is down-sampled to create a low-resolution image. A DNN is then trained using the low-resolution image as input and the high-resolution image as label.

### SUMMARY OF THE INVENTION

In some embodiments, a method of improving a resolution of a system may include training an ML module to predict at least one electromagnetic signal based on at least one input electromagnetic signal; and using the ML module to improve a resolution of the system by: providing to the ML module a set of input electromagnetic signals from an array included in the system; and improving, by the ML module, the resolution of the system by generating and providing at least one additional electromagnetic signal, based on the received set.

An ML module may be trained to artificially increase an aperture's size by predicting an electromagnetic signal outside of the array's aperture. An embodiment may receive input electromagnetic signals from a MIMO radar array and may predict and provide at least one additional electromagnetic signal which is outside a physical or virtual aperture of the MIMO radar array. An ML module may be trained to, and may use the ML module for, increasing resiliency of the system by replacing at least one electromagnetic signal which includes corrupted data with an artificially generated electromagnetic signal.

Training of an ML module may be an unsupervised training including: randomly removing one or more electromagnetic signals from an input set of electromagnetic signals; and training the ML module to predict the removed electromagnetic signal. Training of an ML module may be an unsupervised training including: removing one or more electromagnetic signals from an input set of electromagnetic signals; and training the ML module to predict the removed electromagnetic signal based on other electromagnetic signals included in the input set.

An ML module may be trained to generate an electromagnetic signal based on at least one of: an amplitude and phase of at least one electromagnetic signal included in a set of input electromagnetic signals. An ML module may be trained to predict an electromagnetic signal such that at least one of: an amplitude and phase of the predicted electromagnetic signal is coherent with an amplitude and phase of at least some electromagnetic signals included in a set of input electromagnetic signals.

An electromagnetic signal may include information related to at least one of: range, Doppler, azimuth and elevation. An embodiment may predict an electromagnetic signal by interpolation to thus achieve at least one of: higher Signal to Noise Ratio (SNR) and smaller grating lobes. An embodiment may increase resiliency of a system by replacing at least one electromagnetic signal in a set of electromagnetic signals with an artificially generated electromagnetic signal. An embodiment may artificially increase an aperture of a system by extrapolating an electromagnetic signal outside of an array's aperture. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear. A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Some embodiments of the invention are illustrated by way of example and not of limitation in the figures of the accompanying drawings, in which like reference numerals indicate corresponding, analogous or similar elements, and in which:

FIG. 1A shows a sample from a training dataset used in an experiment with an embodiment of the invention;

FIG. 1B shows a sample from a training dataset used in an experiment with an embodiment of the invention;

FIG. 1C shows a sample from a training dataset used in an experiment with an embodiment of the invention;

FIG. 1D shows a sample from a training dataset used in an experiment with an embodiment of the invention;

FIG. 1E shows a sample from a training dataset used in an experiment with an embodiment of the invention;

FIG. 1F shows a sample from a training dataset used in an experiment with an embodiment of the invention;

FIG. 2A illustrates training mode according to illustrative embodiments of the present invention;

FIG. 2B illustrates inference mode according to illustrative embodiments of the present invention;

FIG. 2C illustrates inference mode according to illustrative embodiments of the present invention;

FIG. 3A shows a model used for prediction of a channel according to illustrative embodiments of the present invention;

FIG. 3B shows a channel attention module according to illustrative embodiments of the present invention;

FIG. 4A illustrates training mode according to illustrative embodiments of the present invention;

FIG. 4B illustrates inference mode according to illustrative embodiments of the present invention;

FIG. 5A illustrates random channel selection and prediction according to illustrative embodiments of the present invention;

FIG. 5B illustrates random channel selection and prediction according to illustrative embodiments of the present invention;

FIG. 6 shows input radar data, predicted data and label data according to illustrative embodiments of the present invention;

FIG. 7A shows a validation dataset according to illustrative embodiments of the present invention;

FIG. 7B shows a validation dataset according to illustrative embodiments of the present invention;

FIG. 7C shows a validation dataset according to illustrative embodiments of the present invention;

FIG. 8A shows a validation dataset according to illustrative embodiments of the present invention;

FIG. 8B shows a validation dataset according to illustrative embodiments of the present invention;

FIG. 8C shows a validation dataset according to illustrative embodiments of the present invention;

FIG. 9C shows a validation dataset according to illustrative embodiments of the present invention;

FIG. 9B shows a validation dataset according to illustrative embodiments of the present invention;

FIG. 9C shows a validation dataset according to illustrative embodiments of the present invention;

FIG. 10 shows a block diagram of a computing device according to illustrative embodiments of the present invention; and

FIG. 11 shows a flowchart of a method according to illustrative embodiments of the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

Unless explicitly stated, the method embodiments described herein are not constrained to a particular order in time or to a chronological sequence. Additionally, some of the described method elements can occur, or be performed, simultaneously, at the same point in time, or concurrently. Some of the described method elements may be skipped, or they may be repeated, during a sequence of operations of a method.

Some embodiments of the invention significantly improve the angular resolution of a RADAR array while decreasing the number of physical receiving channels required. As described, some embodiments use training a DNN with complex range-Doppler RADAR data as input. As described, training may be a self-supervised training using a novel loss function which operates in multiple data representation spaces. Using embodiments of the invention, 4× improved angular resolution were demonstrated using real-world dataset collected in urban and highway environments.

Accordingly, some embodiments of the invention enable real time performance of a DNN based system for coherent RADAR beamforming and super resolution that can be utilized for automotive applications in real-world, urban and highway scenarios. More specifically, some embodiments use an auto-encoder trained in a self-supervised method with a diluted RADAR array and used to reconstruct the amplitude and phase of missing receiving channels. To enforce coherence during the reconstruction process, a novel loss function which operates on multiple data representation spaces may be utilized.

Experiments conducted and described herein demonstrate the novelty and usability of some embodiments of the invention. The experiments described herein clearly show that systems and methods according to some embodiments of the invention improve the resolution of electromagnetic signals or wave-based systems. More specifically, experiments described herein clearly demonstrate how a resolution of a given system, which is limited by the number and sparsity of antennas in an array included in the system, is increased and/or improved to a level that cannot be achieved by the given system alone.

It will be understood that the scope of the invention is not limited by the experiments, nor by the components used in experiments as described herein. For example, different types of antenna arrays or radar systems may be used and/or different types of processors or DNNs may be used Similarly, different constants (e.g., in a loss function) may be used without departing from the scope of the invention.

Although, for the sake of clarity and simplicity, radars and radar systems are mainly described and referred to herein, it will be understood that the scope of the invention is not limited to radars and that the invention may be applicable to any electromagnetic signals or wave-based systems or any relevant system that uses electromagnetic signals. For example, some embodiments of the invention can improve the resolution of any system that receives radio waves or other electromagnetic waves, signals or energy. Accordingly, the terms “RADAR data” and “electromagnetic signals” as referred to herein may relate to the same thing and may be used herein interchangeably. The terms “RADAR”, “RADAR array” and “electromagnetic signal-based system” as referred to herein may relate to the same thing and may be used herein interchangeably. The term “channel” as referred to herein may relate to an electromagnetic signal. For example, a channel may be, or may include, a stream of digital information representing an electromagnetic signal, e.g., a channel may be, or may include, a digital representation of an electromagnetic signal produced by an antenna in radar system 1040.

Testing and validation of some embodiments were performed on a real-world dataset collected using a vehicle mounting a RADAR unit and driven in urban and highway environments, and have shown an improvement with respect to known systems and methods.

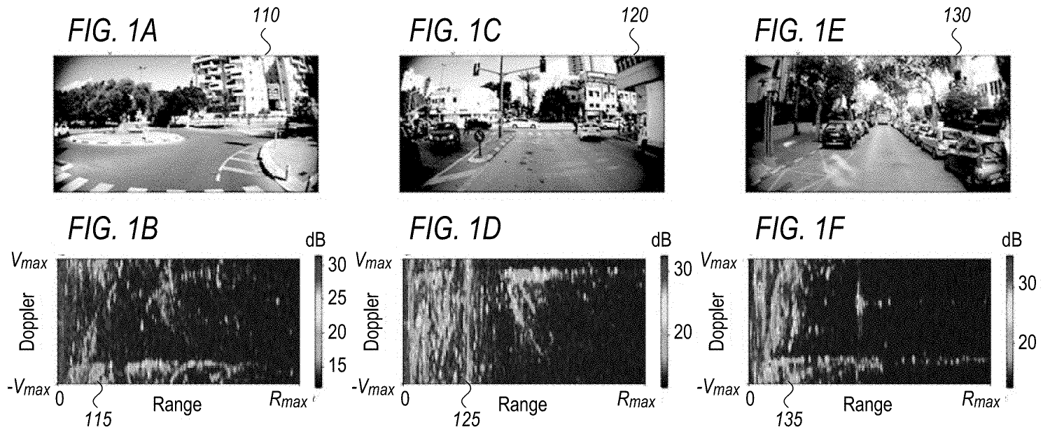

More specifically, in an experiment, a dataset was collected in un-controlled urban and highway environments, using a vehicle mounting a temporally synchronized camera and RADAR with their field of view overlapped. The dataset was split into 54,241 frames for training and 5443 frames for validation. The validation dataset was separated from the training dataset by collecting data during different dates and locations in order to avoid the appearance of similar frames in both datasets, which could have occurred in the case of simple random split. Reference is made to FIG. 1, which shows samples from a training dataset used in an experiment with an embodiment of the invention. As shown in FIG. 1, a set of range-Doppler decibel (dB) maps 115, 125 and 135 may be generated based on respective environments 110, 120 and 130.

In the experiment, a Frequency Modulated Continuous Wave (FMCW) MIMO RADAR with a 79 GHz carrier frequency was used. A FMCW RADAR transmits a linear chirp signal whose frequency increases linearly with time. When combined with means of signal processing (mainly FFT), it is possible to extract useful information from the raw signal such as, range, velocity and DOA.

In the experiment, MIMO RADAR included multiple transmitters (Tx) and receivers (Rx) antennas. In this configuration, each transmitter can output a waveform independently of the other transmitting antennas, while each of the receiving antennas can receive these signals also independently. By processing measurements from different transmit and receive antennas, one can create a virtual aperture whose size is larger than the physical aperture. For example, an antenna array of N_{Tx} transmitters and an array of N_{Rx} receivers results in a virtual array of N_{Tx}×N_{Rx} channels. This increase in aperture size, translates to improved performance such as: spatial resolution, resistance to interference and probability of detection of the targets. Although a collocated MIMO RADAR is mainly described herein, it will be noted that some embodiments of the invention are applicable to any relevant system that uses electromagnetic signals, e.g., a multi-channel RADAR system including non-collocated MIMO RADAR or other multi-channel RADARs.

As used in relevant systems, electromagnetic signal or wave (e.g., a RADAR signal) in its raw form contains a variety of information originating from different physical phenomena in the environment and the specific system (e.g., RADAR system) used. To differentiate between the complex interactions, FFT has long become a staple for RADAR signal processing. More specifically, FFT can be used to transform the signal from its raw form to different representation spaces.

As described, some embodiments of the invention are applicable to (improve, can work with, or be included in) any electromagnetic signal or wave based system, e.g., any RADAR array technology with any number of antennas or channels. To illustrate, in some embodiments, the RADAR used may be a Uniform Linear Array (ULA) antenna array configuration with 16 virtual channels, providing the ability to process amplitude and phase information in 3 dimensions: range, Doppler and azimuth. The waveform used may be configured to 48 sweeps and 256 samples with maximum detection range of 64 m and maximal relative velocity of 5.8 m/s. The FOV (transmitter/receiver FOV overlap) may be configured to 100°. In some embodiments, input to an ML module (as further described herein) is generated by applying a window and FFT on both sweeps and samples dimensions to generate a complex data tensor with the dimensions of: virtual channel, range, and Doppler.

Accordingly, some embodiments of the invention hold several important characteristics with regard to data pre-processing, and these characteristics contribute to the generality and robustness of embodiments of the invention while addressing the shortcoming of current, known or previous approaches to RADAR super-resolution. Specifically, some embodiments of the invention do not require any filtering in order to operate or function properly, nor do some embodiments of the invention require any assumptions on the sparsity of the data. In addition, in systems that include embodiments of the invention, there is no minimum SNR threshold, no calibration is required, there is no maximum number of scatter points, and there are no requirements of prior information on the scene where is system is operating.

A fundamental concept of self-supervised learning involves manipulating, augmenting or masking parts of an input data and then using a DNN to predict the original data, part of the original data or which manipulation was performed. Some embodiments use self-supervision to predict electromagnetic signal (e.g., RADAR data) and treat the super-resolution problem as a signal reconstruction problem while combining it with traditional beamformers. Accordingly, some embodiments can work in combination with other super-resolution methods.

In order to improve resolution of electromagnetic signal or wave-based system, e.g., improve a RADAR array's angular resolution, some embodiments use a DNN to predict received data outside of the physical or virtual array aperture. The combination of the originally received channels and the predicted channels creates an artificial RADAR array with extended or larger aperture and thus improves angular resolution. As used herein, the term “artificial channel” relates to predicted channels, that is, channels predicted, generated and/or provided by an ML module. As used herein, the term “virtual channel” relates to channels created or provided, e.g., by a MIMO or other process as described.

For example, some embodiments may be used to expand a virtual MIMO array and create an artificial array comprised of virtual receiving channels from the MIMO array and artificial receiving channels from the DNN's prediction. Together, all channels can then be used with a beamformer. In some embodiments, FFT may be used as beamformer. However, some embodiments of the invention can also be applied with other beamformers, such as MUSIC or ESPRIT.

One of the challenges met by some embodiments of the invention is maintaining coherence of artificial channels. If coherence is not maintained, the resulting beamforming may not achieve super-resolution. Maintaining coherence is especially challenging since it requires a DNN to extrapolate coherent data for receiving channels positioned far from the original input receiving channels.

Some embodiments of the invention meet this challenge by allowing flexibility in the partitioning between input and label receiving channels. For example, in some embodiments, a ULA with 16 channels, a partitioning of 8 input receiving channels and 8 label receiving channels will result in a 2× angular resolution improvement factor.

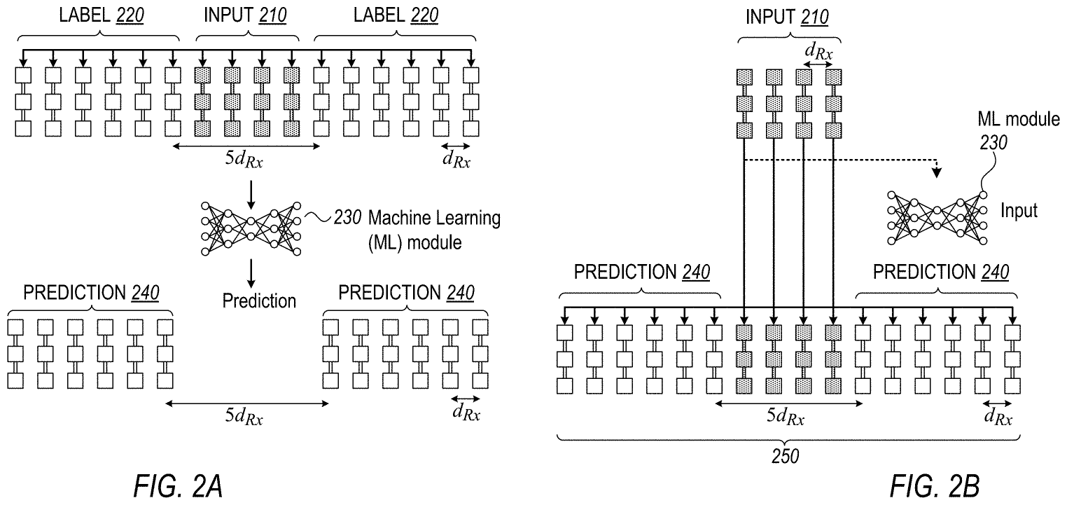

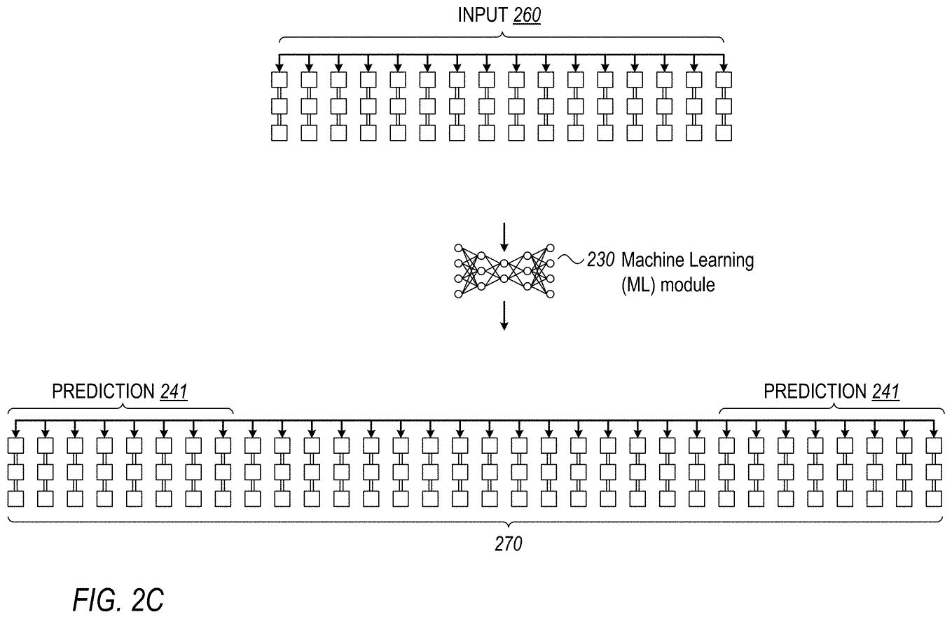

Reference is made to FIGS. 2A and 2B showing input channels 210, label channels (or data) 220, an ML module 230 and predicted channels 240. As shown in FIG. 2A, an array (e.g., ULA) with 16 receiving channels may be used. The central four receiving channels may be used as input 210 to an ML module 230 (DNN), while the remaining twelve receiving channels 220 may be used as label data. As shown by FIG. 2B, during inference mode, the original input receiving channels may be used twice, first as an input to ML module 230 that may use the input to predict, generate and or provide 12 additional receiving channels (prediction 240). Second, they are used together with the predicted receiving channels to create an artificial array, which, as shown by output channels 250, has a total of 16 receiving channels. Accordingly, some embodiments of the invention enable a 4× improved resolution with respect to an original four receiving channels input array.

Generally, FIG. 2A illustrates training mode in which four receiving channels (input 210) are used as input, and, using labeled data 220, an ML module is trained to predict, generate and provide 12 receiving channels outside of the original aperture. FIG. 2B relates to inference mode where an original array is used as input (210) to a DNN or ML module, which predicts adjacent receiving channels outside of the original aperture (prediction 240).

Some embodiments may receive, e.g., during inference, an entire or complete set of channels, e.g., receive all (not only some of the) channels produced or provided by a radar array, and the embodiments may produce or provide an artificial array that is larger than the input array. Accordingly, some embodiments may increase an aperture by providing a set of channels that is larger than an entire original, physical or virtual array.

For example, reference is additionally made to FIG. 2C which, in line with the examples illustrated in FIGS. 2A and 2B, illustrates a case where ML module 230 receives as input 260 an entire set of 16 channels provided by a radar array and, using prediction as described, predicts, generates and provides sixteen channels 241 to thus output an expanded array 270 having 32 channels. Accordingly, some embodiments of the invention may provide channel arrays that represent a size or physical span or layout which is larger than the actual or physical size or physical span or layout of transmitters, receivers or antennas of a system. Otherwise described, any unit or logic receiving array 270, as input from ML module 230, may be unaware, or unable to identify, that some of the channels in array 270 originate from a physical, actual array of antennas while other channels in array 270 are predicted, generated and provided, by ML module 230.

In some embodiments, both input channels 210 and predicted receiving channels 240 are used for coherent beamforming. Accordingly, in this example, the resulting artificial array has sixteen receiving channels (even though a system has only four real receiving channels), and thus an embodiment can provide a 4× improved resolution with respect to the original (real) array of four channels. It is noted that additional or different partitions of input and label receiving channels are possible, that is, some embodiments of the invention are not limited by the example configuration shown in FIGS. 2A and 2B.

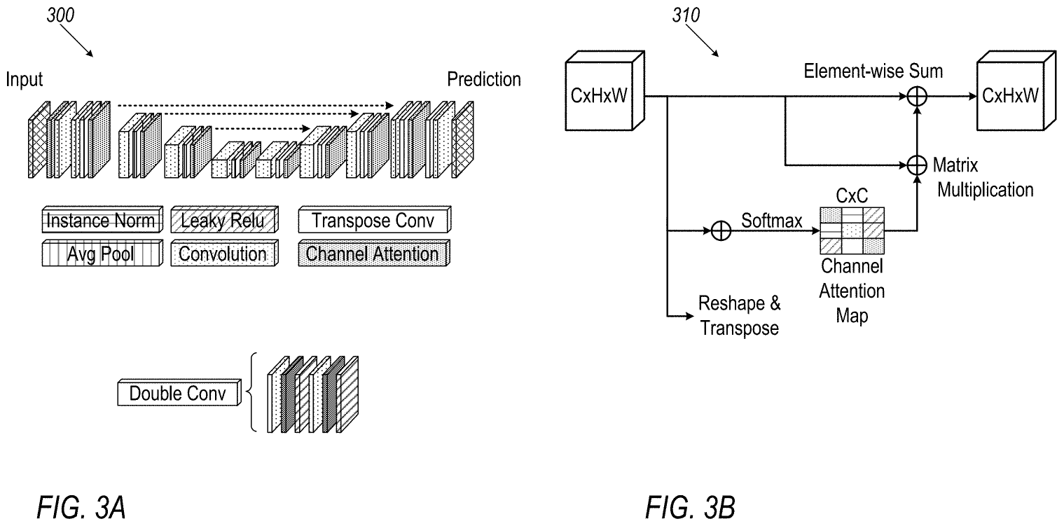

Reference is made to FIG. 3A, which shows a module or model 300 that may be used for prediction of a channel according to illustrative embodiments of the present invention. Reference is additionally made to FIG. 3B, which shows a channel attention module 310 according to illustrative embodiments of the present invention. For example, modules 300 and 310 may be, may include components of, or may be implemented by computing device 1000 described herein. For example, ML module 230 may be, or may include, components of model 300. For example, an ML module (or a model) as shown in FIG. 3A may be based on the encoder-decoder Unet model combined with self-attention layers working on the channel dimension to encourage learned cross channel correlations. Additional layers that may be used are average pooling, leaky-Relu activation and instance normalization. Convolution and transpose convolution may use a 3×3 kernel. In an experiment of an embodiment, a model included about 1.4 million (M) parameters and achieved 15 milliseconds (ms) inference time on a 2080Ti graphics processing unit (GPU). Accordingly, some embodiments of the invention may be highly applicable, beneficial or attractive for embedded, real time applications.

In order to coherently reconstruct a RADAR array's response, some embodiments of the invention include a novel loss function which operates in two data representation spaces simultaneously. It will be understood that, although a specific loss function is described herein, any other loss function may be used by embodiments of the invention. Accordingly, it will be understood that the scope of the invention is not limited by, or to, a specific loss function. As an example of general partitioning, the first representation space may be a range-Doppler which may be used by some embodiments to reconstruct the amplitude. The second representation space (‘Beamformer’) may be achieved by some embodiments by applying FFT on the channel dimension and may be used to reconstruct the phase while enforcing coherence within the array.

Formula 2 below shows loss term as a sum of range-Doppler based and beamformer based losses:

[symbol]

= [symbol] _{rd}+ [symbol] _{bf} Formula 2

where [symbol] _{RD} is the loss term in the range-Doppler representation space, and [symbol] _{bf} is the loss term after applying a beamformer. The resulting multi-objective loss function combines two different physical representations; therefore, addition of such loss terms should be done carefully.

Both loss terms may be composed of three components: reconstruction loss, energy conservation and total variation. In range-Doppler representation space, the loss function may be as shown by formula 3:

[symbol]

_{rd}=λ_{rd}_{_{rec}} [symbol] _{rd}_{_{rec}}+λ_{rd}_{_{energy}} [symbol] _{rd}_{_{energy}}+λ_{rd}_{ₜᵥ} [symbol] _{rd}_{ₜᵥ} Formula 3

where λᵢ are hyperparameters, and [symbol] _{rd}_{_{rec}} is the L2 reconstruction loss, shown in formula 4:

$${ℒ}_{{rd}_{rec}} = \frac{1}{{N}_{i} {N}_{j}} {\sum }_{i , j} {( {y}_{i , j}^{pred} - {y}_{i , j}^{label} )}^{2} \qquad Formula 4$$

with Nᵢ as the number of samples, Nⱼ as the number of receiving channels, y_{i,j}^{pred} as the DNN prediction for sample i of a complex receiving channel j in range-Doppler representation and y_{i,j}^{label} as the paired label. [symbol] _{rd}_{_{energy}} is a smooth L1 energy conservation loss, shown in formulas 5, 6:

$${ℒ}_{{rd}_{energy}} = \frac{1}{{N}_{i} {N}_{j}} {\sum }_{i , j} {z}_{i , j} \qquad Formula 5$$

$${z}_{i , j} = \{ \begin{matrix}0.5 {( \vert {y}_{i , j}^{pred} \vert - \vert {y}_{i , j}^{label} \vert )}^{2} \\ \vert \vert {y}_{i , j}^{pred} \vert - \vert {y}_{i , j}^{label} \vert \vert - 0.5\end{matrix} \begin{matrix}if \vert \vert {y}_{i , j}^{pred} \vert - \vert {y}_{i , j}^{label} \vert \vert < 0. 5 \\ otherwise\end{matrix} \qquad Formula 6$$

with |y_{i,j}^{pred}| as the amplitude of the DNN's prediction. Displayed in formulas 7 and 8, [symbol] _{rd}_{ₜᵥ} is the total variation loss calculated over the range and Doppler dimensions:

$${ℒ}_{{rd}_{t ν}} = \frac{1}{{N}_{i} {N}_{j}} {\sum }_{i , j} t {v}_{i , j} \qquad Formula 7$$

$$t {v}_{i , j} = \frac{1}{{N}_{k} {N}_{l}} {\sum }_{k , l} \vert \vert {y}_{i , j}^{pred} ( k , l ) \vert - \vert {y}_{i , j}^{pred} ( k - 1 , l - 1 ) \vert \vert \qquad Formula 8$$

where (Nₖ, Nₗ) are the number of range and Doppler bins, respectively. In some embodiments, all three loss terms may be calculated per receiving channel separately to enforce tighter constraints and facilitate better reconstruction results.

In the beamformer representation space, [symbol] _{bf} may be calculated with similar expressions for the reconstruction loss, energy conservation and total variation. Key differences may be made in order to encourage correct phase reconstruction. For example, the reconstruction loss may be calculated globally, as to enforce coherence between the different channels as shown in formula 9:

$${ℒ}_{{bf}_{rec}} = \frac{1}{{N}_{i}} {\sum }_{i} {( {y}_{i}^{pred} - {y}_{i}^{label} )}^{2} \qquad Formula 9$$

In addition, energy conservation loss may be calculated per azimuth bin, as shown in formula 10:

$${ℒ}_{{bf}_{energy}} = \frac{1}{{N}_{i} {N}_{m}} {\sum }_{i , m} {z}_{i , m} \qquad Formula 10$$

where Nₘ is the number of azimuth bins. Total variation may be performed on the range and azimuth dimensions, as shown in formulas 11, 12:

$${ℒ}_{{bf}_{tv}} = \frac{1}{{N}_{i} {N}_{m}} {\sum }_{i , m} t {v}_{i , m} \qquad Formula 11$$

$$t {v}_{i , j} = \frac{1}{{N}_{k} {N}_{m}} {\sum }_{k , m} \vert \vert {y}_{i , j}^{pred} ( k , m ) \vert - \vert {y}_{i , j}^{pred} ( k - 1 , m - 1 ) \vert \vert \qquad Formula 12$$

Hyperparameters (λᵢ) tuning may be performed empirically.

Various methods or techniques may be used by some embodiments of the invention in order to train a DNN and/or create an ML module. For example, in testing and experimenting with some embodiments, training of a DNN (or creating a model or an ML module) was done using Pytorch machine learning framework, using the Adam optimizer with β₁=0.9, β₂=0.999, batch size 16 and learning rate utilizing cosine decay from 3.141e⁻⁴ to 3.141e⁻⁷. In testing and experimenting with some embodiments, training was continued until convergence was achieved, for example, using 2080Ti GPU training took about 30 epochs when testing an embodiment.

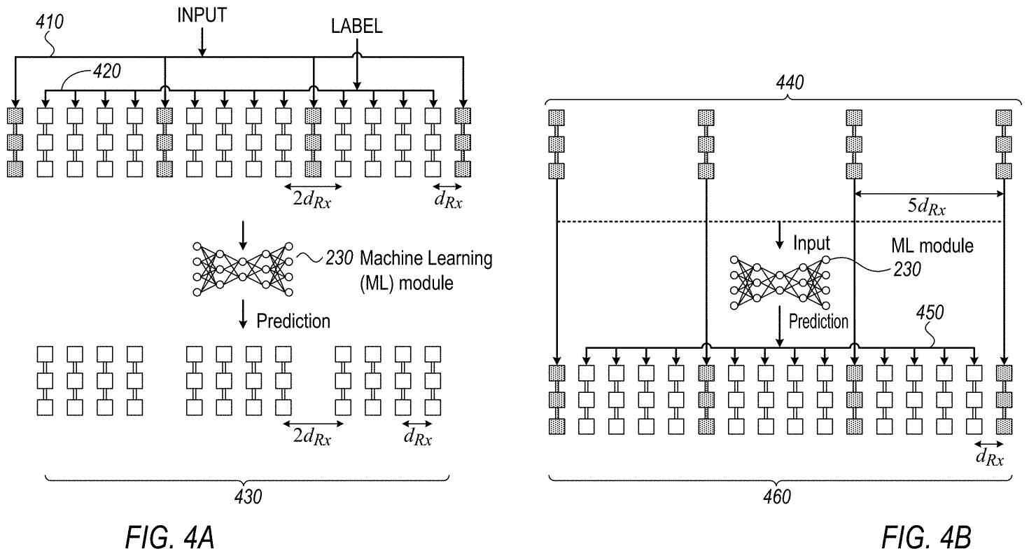

Reference is made to FIG. 4A, which illustrates training mode according to illustrative embodiments of the present invention. Reference is additionally made to FIG. 4B, which illustrates inference mode according to illustrative embodiments of the present invention. Generally, FIGS. 4A and 4B illustrate coherent beamforming using self-supervised learning (e.g., training mode) and operation (e.g., providing coherent beamforming at inference).

Given a RADAR array (or other relevant system as described), some embodiments of the invention allow for, or enable, design flexibility in the partitioning between input and label receiving channels. As an additional example for this degree of freedom, an additional configuration is demonstrated in FIG. 4A, where an array of sixteen receiving channels is split into four input receiving channels 410 spread uniformly across the original array and twelve label receiving channels 420. As shown, in some embodiments, an ML module 230 may (be trained to) reconstruct a full 16 receiving channel RADAR array 430 based on input receiving channels 410 and label receiving channels 420. d_{Rx} shown in FIG. 4A is the distance between adjacent receiving channels.

An example of an inference mode for this configuration is shown in FIG. 4B, where the four input receiving channels are first used with a DNN or ML module to predict twelve coherent artificial receiving channels. In some embodiments, both input and predicted receiving channels are arranged in their correct places in an array to allow for coherent beamforming. As illustrated in FIG. 4B, at inference mode, input receiving channels 440 are first used by ML module 230 (or by a DNN) to predict artificial (predicted) receiving channels 450, each at specific missing locations in a full, ordered array 460. In some embodiments, both input receiving channels 440 and predicted (or artificial) receiving channels 450 are used for coherent beamforming. It will be noted that the configuration shown in FIGS. 4A and 4B is one of many configurations that may be contemplated, and the scope of the invention is not limited by the example configurations shown.

For example, the configuration shown in FIG. 4B may be used to predict receiving channels in a MIMO virtual array based on neighboring channels. Meaning, a DNN or ML module may be used to interpolate missing receiving channels in a MIMO virtual array. Performance increase using this configuration can be achieved in at least two ways. First, given a specific performance metric, in some embodiments it is possible to decrease the number of receiving channels while still retaining high level of performance, thus saving cost and simplifying system architecture and design.

Second, given a specific number of receiving channels, this configuration allows increase of the aperture size (thus improving the angular resolution) and retaining coherent beamforming with high SNR and low sidelobes. These advantages may be achieved by embodiments of the invention e.g., by rearranging the receiving channels and spreading them over a larger aperture size, which improves the angular resolution. It is noted that simply increasing the distance between each receiving channel can decrease the array's performance significantly. To this end, in some embodiments, a DNN may be used to fill in the gaps with coherent artificial receiving channels and thus match the performance of a larger array.

In addition to super-resolution as described, some embodiments of the invention can be used for other purposes. For example, in scenarios where a receiving channel becomes corrupt or exhibits performance degradation during runtime operation, some embodiments may replace the corrupt receiving channel with an artificial receiving channel. For example, in some embodiments, a DNN (or model or ML module) may be trained to, and/or used for, identifying that data in a channel is corrupted and generating and providing, data of a missing or corrupted channel.

For example, some embodiments may predict a random (or randomly) missing one or more receiving channels from a reminder, or input RADAR array. Prediction of a randomly selected channel in a set of channels is especially challenging for a DNN, since the missing receiving channel is randomly chosen and can also be located at the edges of the array, meaning that the DNN needs to extrapolate as well as interpolate.

In some embodiments, in order to meet the challenge and to create a DNN or ML module which is invariant to the position (or location in a set) of a missing receiving channel, the transformer training methodology was used as inspiration. For example, in some embodiments, during training, a full MIMO virtual array may be used as input, and a randomly chosen receiving channel may be masked while a DNN is tasked to predict the missing receiving channel. The resulting trained DNN may accordingly be invariant to the specific receiving channel missing and may thus be able to reconstruct the data of any/each receiving channel individually without the need to train a separate model, DNN or ML module for each receiving channel.

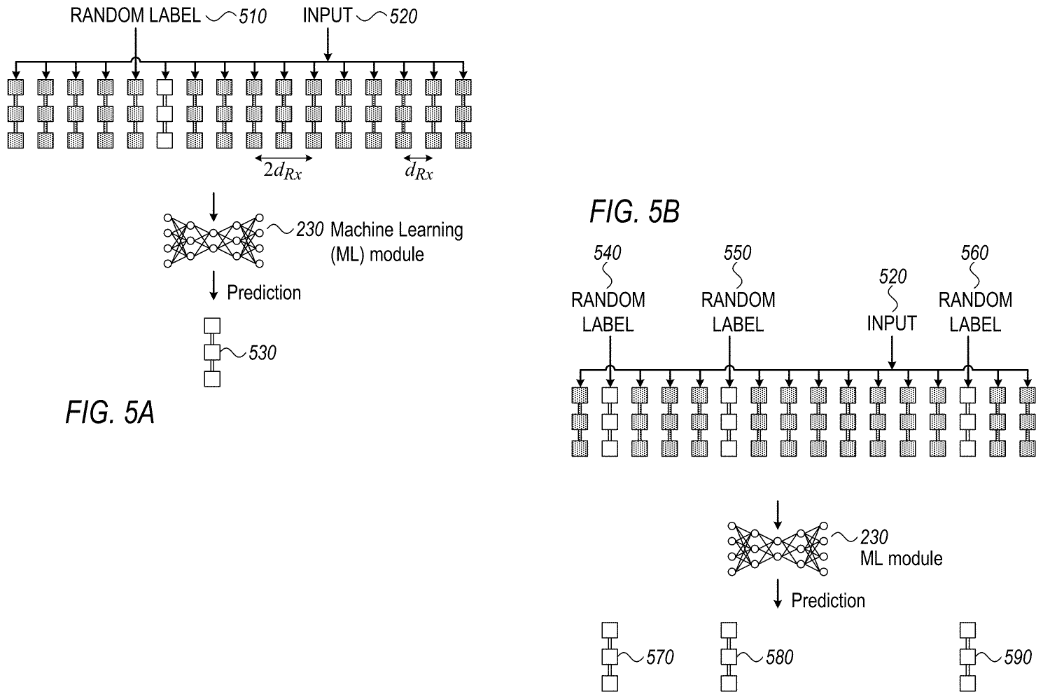

Reference is made to FIG. 5A, which illustrates random channel selection and prediction according to illustrative embodiments of the present invention. As illustrated, an embodiment may, during training an ML module 230, randomly select to mask a receiving channel. Masking a channel may include any method or technique that prevents a channel from reaching ML module while the rest of the channels 520 are provided to ML module 230, e.g., a channel may be blocked or disconnected such that it does not reach ML module 230. For example, during training, receiving channel 510 may be randomly selected from the set of receiving channels 520, and ML module 230 may be trained to predict, generate and provide (missing, masked or blocked) receiving channel 510 as shown by channel 530. A masked channel may be used as label data when ML module 230 attempts to reconstruct, predict or provide the masked channel.

Of course, training ML module 230 may include a large number of iterations where, in each or some of the iterations, different receiving channels are selected to be masked (or otherwise prevented from being provided to ML module 230). It is noted that, since the missing receiving channel can be at any location in an array, ML module 230 may be trained to predict, generate and provide channels by interpolation (e.g., when the masked channel is not at an edge of an array), and/or by extrapolation (e.g., when the masked channel is at an edge of an array being reconstructed).

Some embodiments of the invention enable or support numerous possible permutations for the choice between input and label receiving channels. For example, experiments were performed using an example configuration of an embodiment as shown in FIGS. 2A, 2B, 4A and 4B, where four (out of sixteen) receiving channels are used as an input RADAR array, while the other twelve receiving channels are used as label, meaning that the combined array has 4× improved resolution than the input array.

In an experiment, input to a model (ML module) was a diluted 1D sub-array of complex (both amplitude and phase) range-Doppler maps, and the ML module was tasked with predicting and providing remainder label range-Doppler maps. Data pre-processing and waveform configuration were done as described herein.

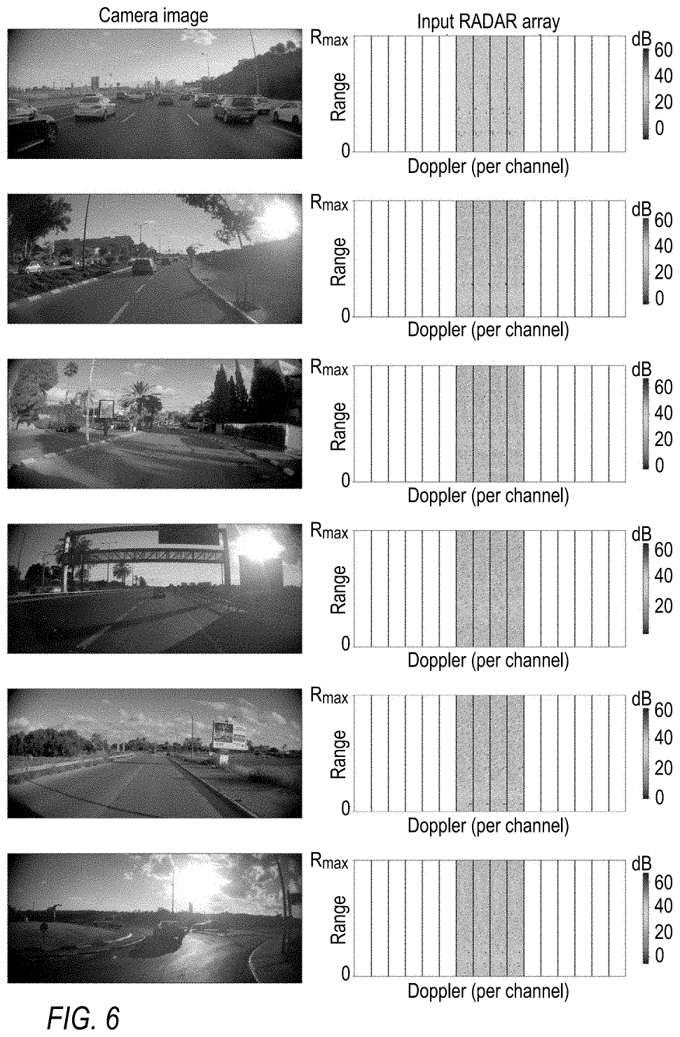

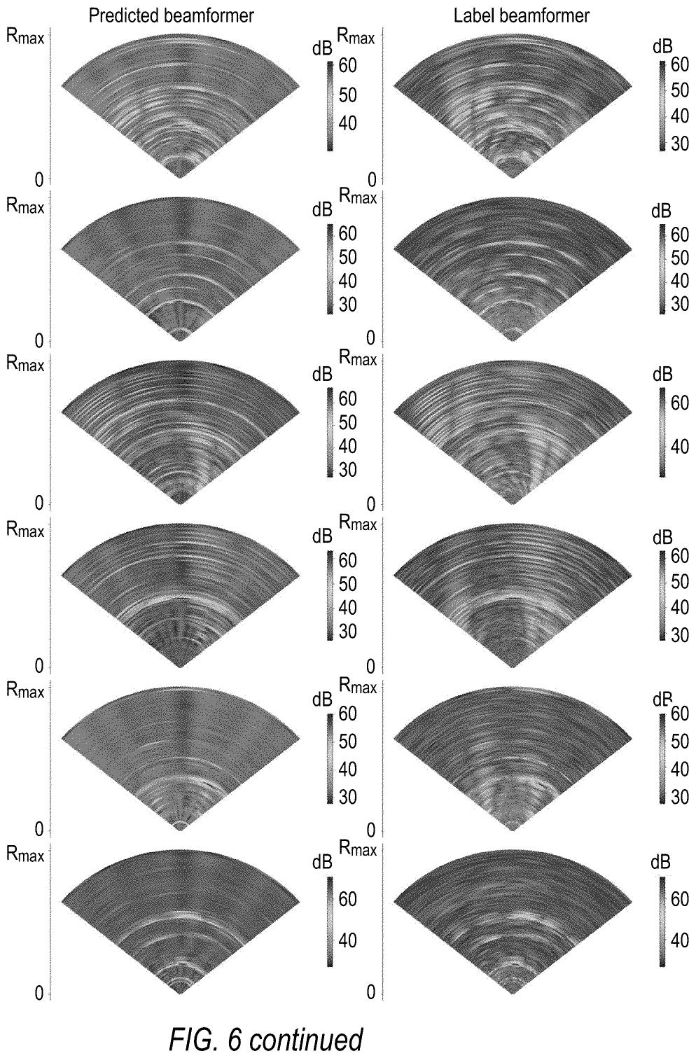

Reference is made to FIG. 6, which shows input radar data, predicted data and label data according to illustrative embodiments of the present invention. FIG. 6 shows data related to several representative scenarios in urban and highway environments collected in an experiment with an embodiment of the invention as well as data generated (predicted) in the experiment. Also shown in FIG. 6 are cartesian view comparisons between the label and predicted beamformers which were obtained by performing FFT on the channel dimension of the original array and the predicted array as shown in FIG. 2. These results demonstrate the use of an embodiment of the invention to super-resolve a low angular resolution RADAR array, thereby achieving 4× improved resolution in scenarios representing various combinations of dynamic and static objects, including vehicles, vegetation, sidewalks, poles and structures.

In FIG. 6, each row corresponds to a single frame. The camera images are introduced for convenience and reference only. The input RADAR array is displayed in dB. Empty spaces were left to orient the reader as to which receiving channels were used as input. The predicted beamformer (values in dB) is displayed in cartesian coordinates and was generated by an embodiment including a DNN trained in a self-supervised method to predict receiving channels. The combined input and predicted receiving channels are then used by a beamformer. Coordinate transformation was used to transform from range-Doppler-azimuth to cartesian coordinate frame with averaging over the Doppler dimension. The label beam former (with values in dB) shows the corresponding original array after beamforming in cartesian coordinates. It will be noted that some embodiments of the invention enable additional partitions of input and label receiving channels.

Another experiment included using two evaluation metrics: L1 and SNR. Both were averaged over the validation dataset. Lower L1 error corresponds to improved reconstruction and was calculated by formula 13:

$$L 1 = \frac{1}{{N}_{i} {N}_{j}} {\sum }_{i , j} \frac{\vert {y}_{i , j}^{pred} - {y}_{i , j}^{label} \vert}{\vert {y}_{i , j}^{label} \vert} \qquad Formula 13$$

where L1 is the reconstruction metric. In the range-Doppler representation space, both metrics were calculated for each receiving channel separately, while in the beamformer representation space (i.e., rang-Doppler-azimuth), the metrics were calculated for each azimuth bin separately.

Since some embodiments of the invention deal with coherent reconstruction of an array's response, the important metrics are associated with the beamformer representation space and more specifically, its SNR. Higher SNR in this space correlates to coherent beamforming.

Table 1 displays an ablation study performed on a loss function according to some embodiments of the invention as described herein and averaged over the validation dataset. The results show that the best performances (shown in bold) are achieved by using all parts of the loss function, suggesting improved coherence is attained, by embodiments of the invention, by adding the beamformer constraints to the training process. In addition, the results in Table 1 also show the importance of energy conservation during a signal reconstruction process.

TABLE 1

| | Range-Doppler | | Beamformer | |
|---|---|---|---|---|
| Loss | L1 | SNR | L1 | SNR |
| [symbol] _{rd}_{_{rec}} | 0.813 | 5.281 | 0.402 | 15.691 |
| [symbol] _{rd}_{_{rec}} + [symbol] _{rd}_{_{energy}} | 0.331 | 28.670 | 0.396 | 20.143 |
| [symbol] _{rd} | 0.329 | 28.673 | 0.377 | 20.013 |
| [symbol] _{rd} + [symbol] _{bf}_{_{rec}} | 0.383 | 18.409 | 0.390 | 16.616 |
| [symbol] _{rd} + [symbol] _{bf}_{_{rec}} + [symbol] _{bf}_{_{energy}} | 0.325 | 30.209 | 0.386 | 22.339 |
| [symbol] _{rd} + [symbol] _{bf} | 0.323 | 30.236 | 0.361 | 22.351 |

In Table 1, L1 and SNR metrics are for both range-Doppler representation and beamformer representation (range-Doppler-azimuth). The results were averaged over the validation dataset. High SNR in the beamformer representation space suggests coherent reconstruction.

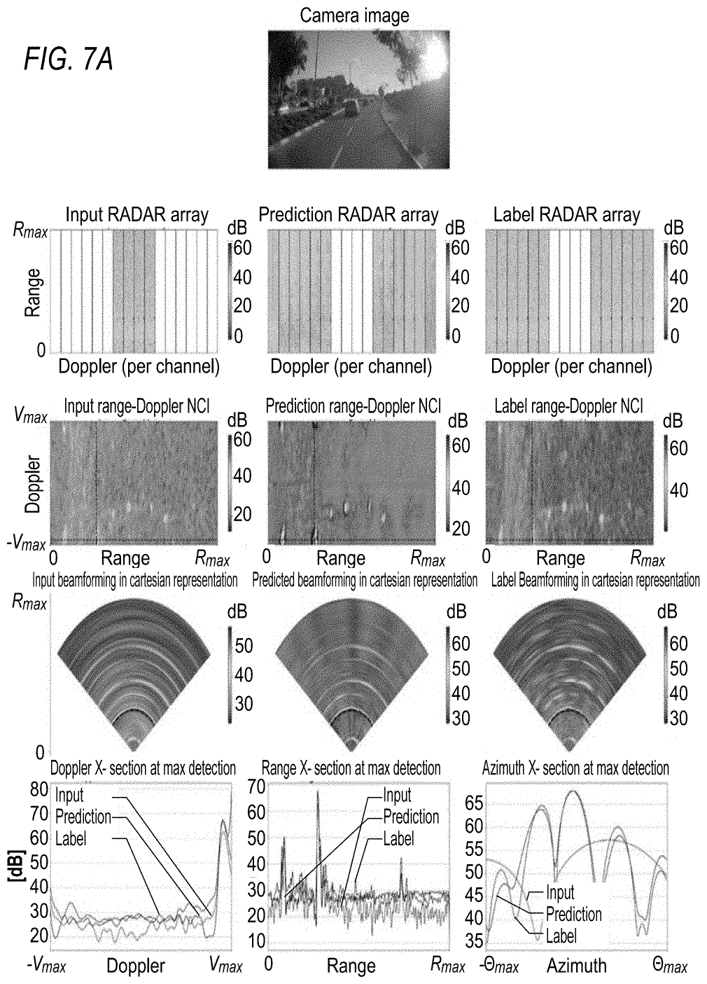

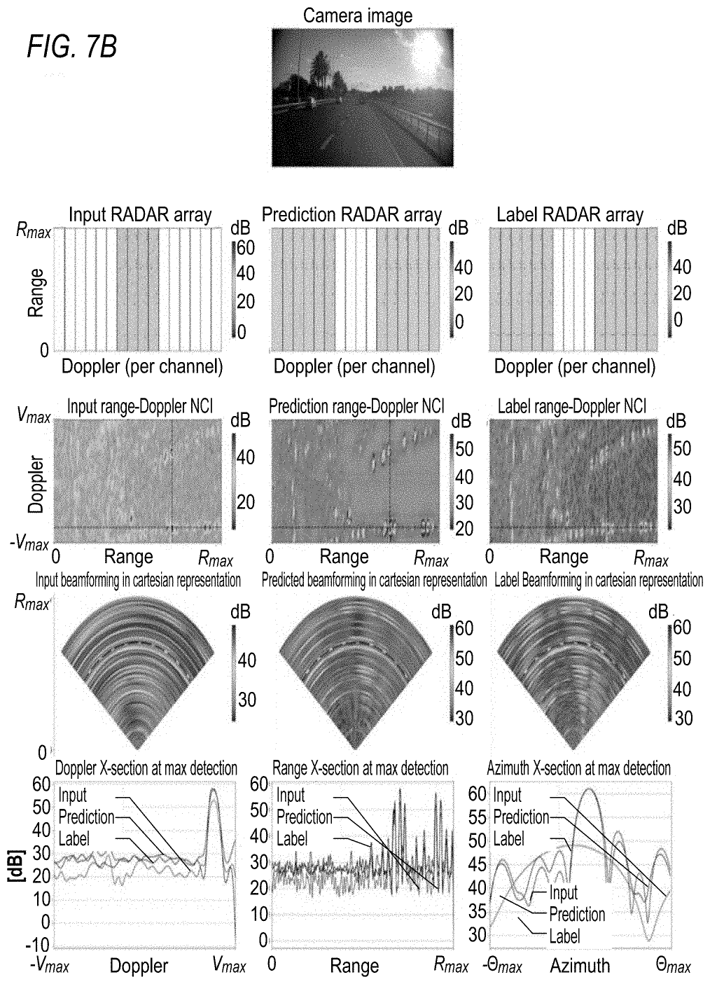

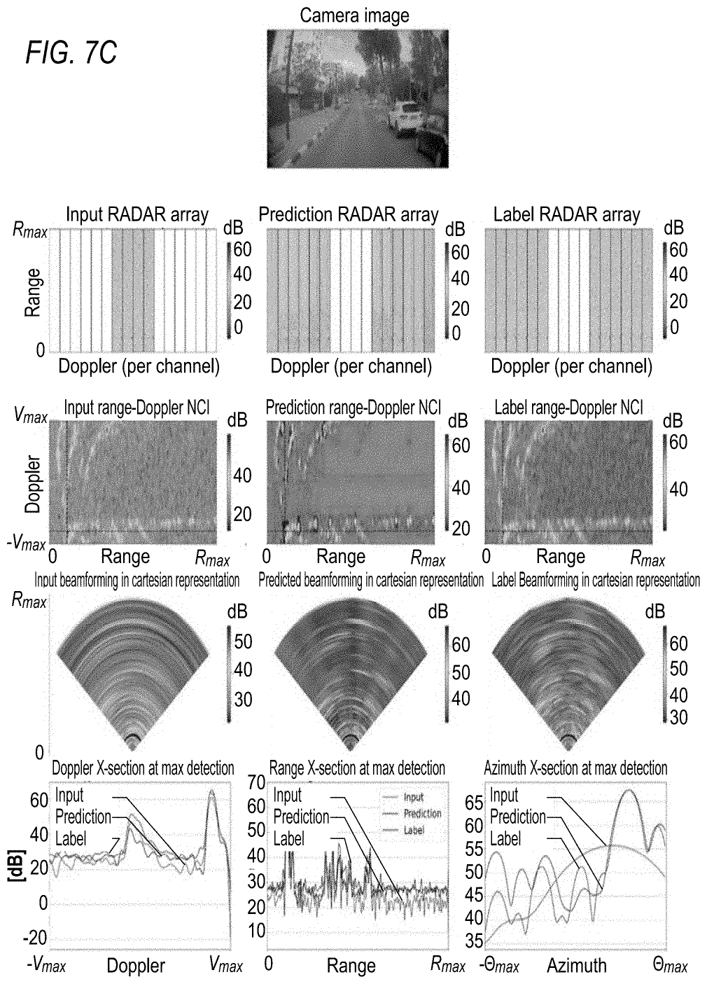

Reference is made to FIG. 7A, which shows a validation dataset according to illustrative embodiments of the present invention. Reference is additionally made to FIG. 7B, which shows a validation dataset according to illustrative embodiments of the present invention. Reference is additionally made to FIG. 7C, which shows a validation dataset according to illustrative embodiments of the present invention. FIGS. 7A, 7B and 7C show detailed results for respective three representative cases. Generally, each of FIGS. 7A, 7B and 7C includes three columns for input data, predicted data and label data.

As shown, each of FIGS. 7A, 7B and 7C includes a reference camera image, input RADAR array, predicted RADAR array and label RADAR array, with values in dB. Empty spaces were left to orient the reader as to which receiving channel belongs to each group. In addition, range-Doppler Non-Coherent Integration (NCI) is shown for each array with values in dB and also showing the maximum detection in dotted black lines. The three arrays are also displayed in cartesian coordinates with values in dB and a dotted black line signifying the maximum detection range. Three cross sections of the maximum detection are displayed showing the input, predicted and label arrays. In the representative scenarios, the vehicles detections occupy significant angular coverage in the low-resolution RADAR (input RADAR array), sometimes blocking an open road, which illustrates the critical need for high resolution RADARs. The results show that, by using an embodiment of the invention, the input array is super-resolved to match the performance of the label array. FIG. 7B displays a sample of a stationary scenario, meaning the RADAR is not moving, with similar results to samples where the RADAR was moving. These results suggest that embodiments of the invention do not rely solely on Doppler and micro-Doppler effects during the prediction or reconstruction process.

The critical importance of high angular resolution for automotive RADARs can be further understood by examining common everyday driving scenarios as demonstrated in FIGS. 7A, 7B and 7C. These examples demonstrate how low-resolution RADARs (i.e., the input RADAR array used) can falsely detect objects in front of the vehicle even though the road ahead is clear. In addition, adjacent objects can also be falsely detected as a single object. These highly undesired phenomena can be resolved by using embodiments of the invention to improve the angular resolution of the RADAR array.

To further support additional applications or use of embodiments of the invention, experiments were performed with a different permutation of input and label receiving channels denoted ‘sparse array configuration’ as shown in FIG. 4. As illustrated in FIG. 4, some embodiments of the invention may be used to interpolate receiving channels between sparsely spaced input receiving channels.

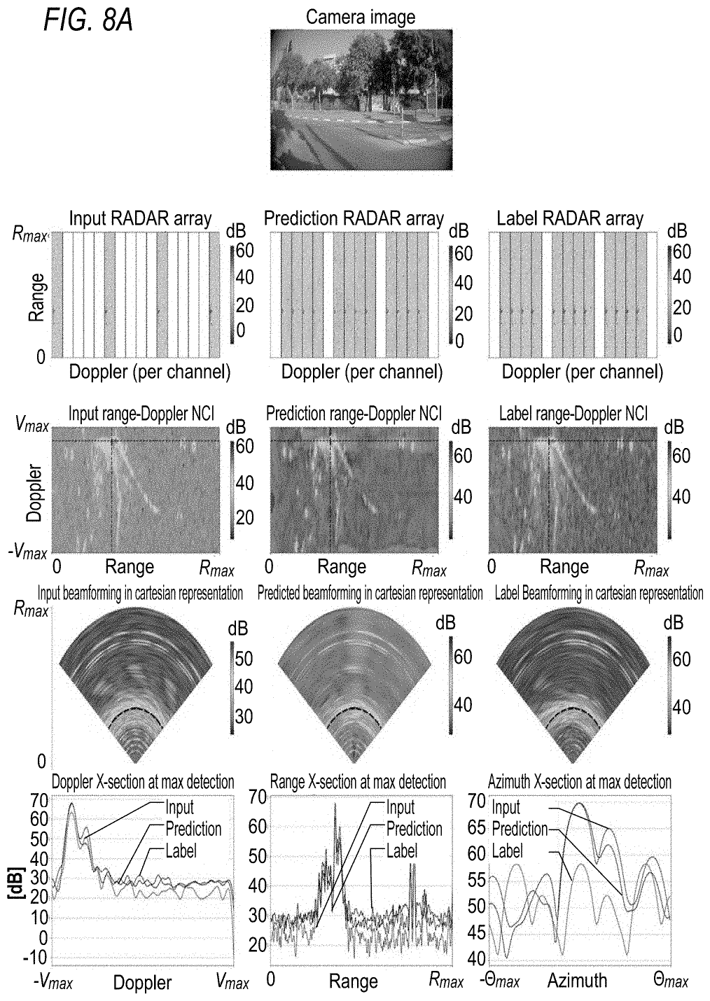

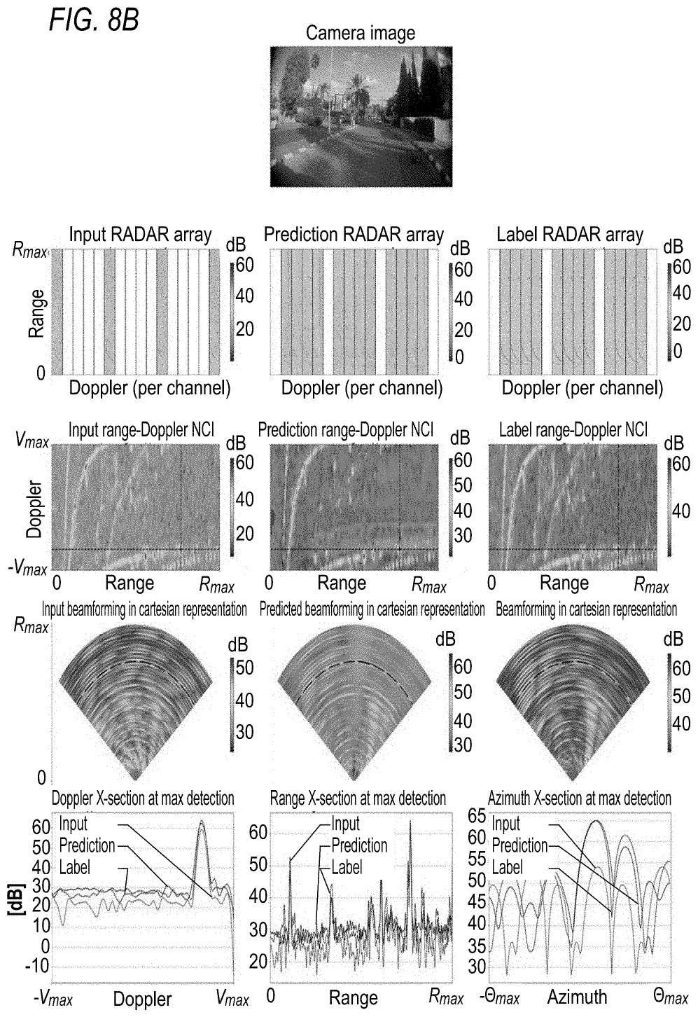

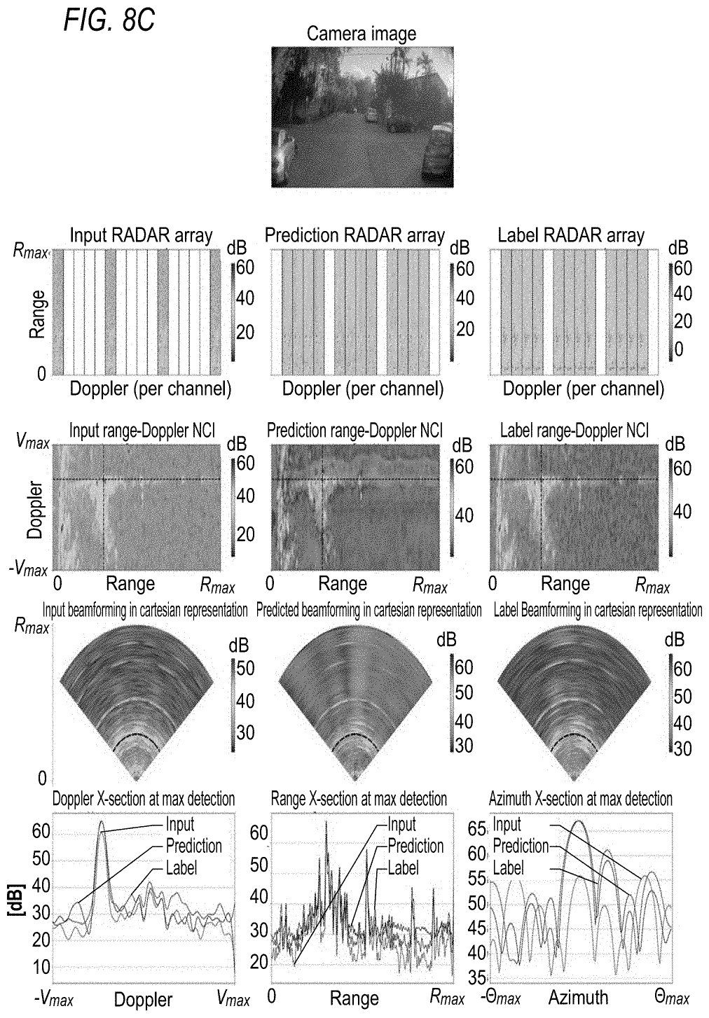

Reference is made to FIG. 8A, which shows a validation dataset according to illustrative embodiments of the present invention. Reference is additionally made to FIG. 8B, which shows a validation dataset according to illustrative embodiments of the present invention. Reference is additionally made to FIG. 8C, which shows a validation dataset according to illustrative embodiments of the present invention. FIGS. 8A, 8B and 8C show sample results from a validation dataset for the sparse array configuration described herein. Generally, each of FIGS. 8A, 8B and 8C includes three columns for input data, predicted data and label data.

As shown, each of FIGS. 8A, 8B and 8C includes a reference camera image, input RADAR array, predicted RADAR array and label RADAR array, with values in dB. Empty spaces were left to orient the reader as to which receiving channel belongs to each group. In addition, range-Doppler Non-Coherent Integration (NCI) is displayed for each array with values in dB and also showing the maximum detection in dotted black lines. The three arrays are also displayed in cartesian coordinates with values in dB and a dotted black line signifying the maximum detection range. Three cross sections of the maximum detection are displayed showing the input, predicted and label arrays. These results show that beamforming on the input RADAR array suffers from degraded performance due to grating lobes caused by the large distance between each antenna element. As shown, using an embodiment of the invention, the gaps are filled and the performance of the predicted beamformer matches the label beamformer. Note that additional partitions of input and label receiving channels are possible by appropriate configuration of embodiments of the invention, meaning that some embodiments of the invention are not limited by the examples illustrated by in FIGS. 8A, 8B and 8C.

Sample results shown in FIGS. 8A, 8B and 8C relate to a scenario where four uniformly spaced receiving channels are used as input and twelve receiving channels are used as label. In this configuration, the resolution of the input and label arrays are similar (they share aperture size), but, due to the large spacing between receiving antenna elements in the input array, the input beamformer suffers from high grating lobes which severely degrade performance. When used in an experiment, an embodiment of the invention (a DNN trained as described, e.g., ML module 230) was able to coherently reconstruct the missing receiving channels and match the performance of the label array.

Additional experiments and validations of the sparse array configuration were performed on the validation dataset and compared to bi-cubic interpolation (where possible). The results provided in Table 2 show that bi-cubic interpolation does not enforce coherence during the reconstruction process, as evident by the low SNR in the beamformer representation space. In contrast, an embodiment of the invention is able to reconstruct the array correctly and coherently.

TABLE 2

| | Range-Doppler | | Beamformer | |
|---|---|---|---|---|
| | L1 | SNR | L1 | SNR |
| Bi-cubic | 0.372 | 27.318 | 0.513 | 13.089 |
| Embodiment of | 0.356 | 29.029 | 0.374 | 21.647 |
| the invention | | | | |

In Table 2, loss metrics for the sparse array configuration are averaged over the validation dataset. Higher SNR in the beamformer representation space by an embodiment of the invention in comparison to bi-cubic interpolation further suggests coherent reconstruction by the embodiment.

Since some embodiments of the invention use signal reconstruction to improve resolution, they can also be used for mitigation of hardware failure. More specifically, in cases where a receiving channel is corrupted, some embodiments of the invention can be used to replace it with an artificial receiving channel. This configuration, denoted ‘random missing channel configuration’, is illustrated in FIG. 5A. Although, for the sake of clarity and simplicity, randomly or otherwise blocking, masking or removing a single channel in an input set of channels is described herein, it will be understood that any number of channels may be randomly blocked, masked or removed. For example, reference is additionally made to FIG. 5B, which illustrates random channel selection and prediction according to illustrative embodiments of the present invention. As shown, e.g., during training, a set of channels 540, 550 and 560 may be randomly selected to be masked or blocked, such that ML module 230 receives all other channels of input 520 but does not receive channels 540, 550 and 560 which may be used as label data in training ML module 230 to predict, generate, reconstruct and/or provide the missing channels 540, 550 and 560 as respectively shown by predicted channels 570, 580 and 590. Accordingly, e.g., in inference mode, ML module 230 may reconstruct, predict, generate and provide a large number of missing channels, e.g., in a case where a number of antennas in an array are non-functional.

To test, demonstrate and/or validate the ‘random missing channel configuration’ approach, experiments were performed where a DNN trained as described was used to estimate a random missing receiving channel (in the general case, it is noted that more than one random receiving channel can be predicted). Since the position of the missing receiving channel can vary and is not known in advance, the DNN first needs to determine if each receiving channel is corrupt and, if so, coherently reconstruct it based on remainder (other) receiving channels in a set.

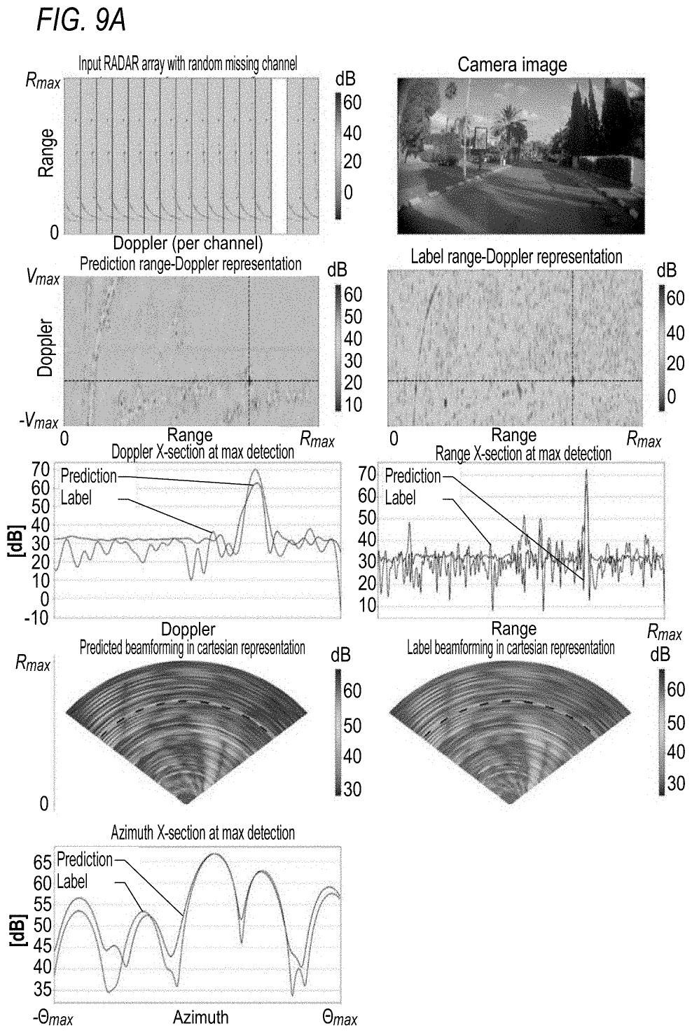

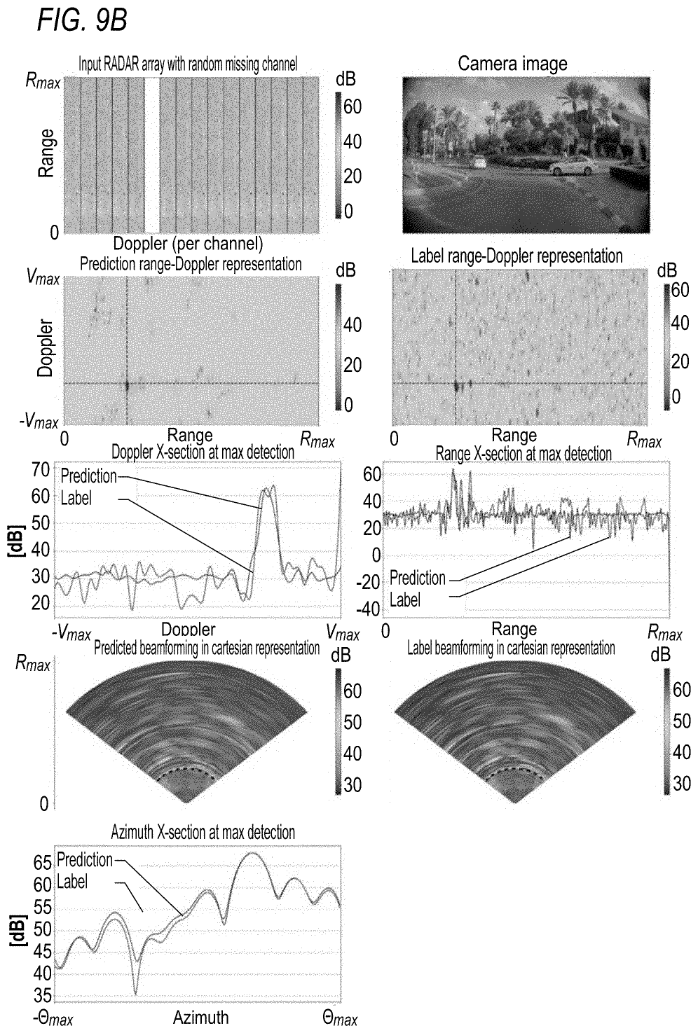

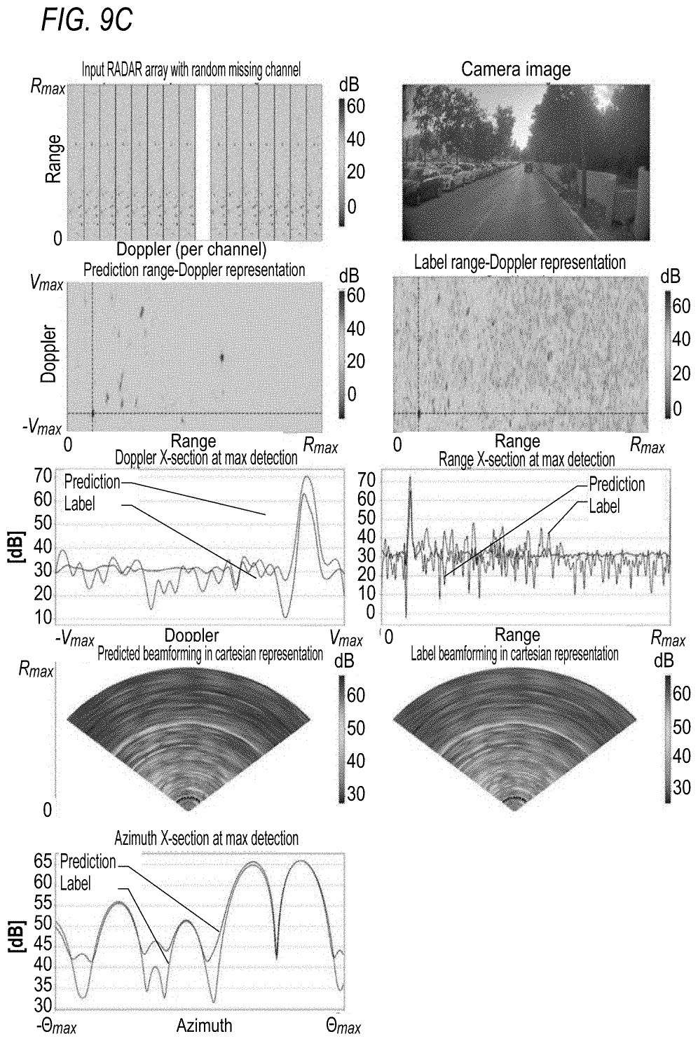

Sample results from the validation dataset are shown in FIGS. 9A, 9B and 9C, to which reference is additionally made. Reference is made to FIG. 9A, which shows a validation dataset according to illustrative embodiments of the present invention. Reference is additionally made to FIG. 9B, which shows a validation dataset according to illustrative embodiments of the present invention. Reference is additionally made to FIG. 9C, which shows a validation dataset according to illustrative embodiments of the present invention. FIGS. 9A, 9B and 9C show sample results from a validation dataset for the random missing channel configuration described herein. As shown, each one of FIGS. 9A, 9B and 9C includes a reference camera image, input RADAR array with values in dB and an empty space signifying the missing receiving channel. In addition, range-Doppler maps are displayed for the predicted and label receiving channels with values in dB and also showing the maximum detection in dotted black lines. The predicted and label arrays are also displayed in cartesian coordinates with values in dB and a dotted black line signifying the maximum detection range. Three cross sections of the maximum detection are displayed showing the input, predicted and label arrays. These results show that, by using embodiments of the invention, it is possible to overcome a randomly placed missing receiving channel and match the performance of the label array. It will be noted that the configuration illustrated in FIGS. 9A, 9B and 9C can also be used with more than one missing channel.

Quantitative comparison over the validation dataset is provided in Table 3, where, as shown, an embodiment of the invention outperforms bi-cubic interpolation. Note that bi-cubic interpolation cannot estimate receiving channels at the edge of an array, whereas some embodiments of the invention are able to extrapolate as well as interpolate. Thus, some embodiments of the invention can estimate, predict, generate and provide, missing receiving channels at the edge of an array.

TABLE 3

| | Range-Doppler | | Beamformer | |
|---|---|---|---|---|
| | L1 | SNR | L1 | SNR |
| Bi-cubic | 0.763 | 11.859 | 0.191 | 21.324 |
| Embodiment of | 0.307 | 30.231 | 0.127 | 21.597 |
| the invention | | | | |

In Table 3, loss metrics for random missing channel configuration are averaged over the validation dataset. Note that bi-cubic interpolation cannot be used to estimate the channels at both ends of the array. In this configuration, low L1 and high SNR in the range-Doppler representation suggest superior performance by the suggested method.

Insufficient angular resolution is one of the limiting factors in automotive RADAR applications. Current systems and methods attempt to improve angular resolution by increasing the number of physical receiving channels. However, known systems and methods suffer from a number of drawbacks. For example, they increase system complexity, require cumbersome calibration processes, add sensitivity to hardware failure, decrease power efficiency and come with higher cost. Some known systems and methods use super-resolution algorithms. However, this approach introduces latency due to slow run time, sensitivity to SNR, limitations on the number of targets and in some cases, a requirement for prior knowledge on the environment.

Some embodiments of the invention overcome the above-mentioned drawbacks of known systems and methods by, for example, using a single snapshot (frame) as input which is an important property in automotive applications where reaction time is critical. Furthermore, the dataset with which some embodiments of the invention were tested was collected in un-controlled urban and highway environments and was not focused on a specific class of objects, yet, as described, some embodiments of the invention showed high accuracy even in such uncontrolled environments.

It is further noted that, unlike known systems and methods, in some embodiments of the invention, a pre-processing stage does not include special filtering nor requires any calibration process. Moreover, in some embodiments of the invention, there is no requirement for prior knowledge on the number of targets in a scene and no minimum SNR threshold. In addition, in some embodiments of the invention, the run-time is invariant to the number of detections in a frame. Accordingly, when some embodiments of the invention are used as described, a highly cluttered scene will not cause a bottleneck in processing time which is an important characteristic in real-time applications.

Some embodiments of the invention can replace, or be used in addition to, existing super-resolution methods and uses self-supervised learning to train a DNN to predict artificial receiving channels in range-Doppler representation outside of an array's aperture. As described, the combined, original and artificial receiving channels create a larger aperture, and, if, as described, coherence is maintained, the improvements of the larger array are improved angular resolution and higher SNR.

In some embodiments, e.g., in order to enforce coherence, additional constraints may be introduced during the training process. For example, constraints in the form of additional loss terms operating in the beamformer representation space. In some embodiments, training may be performed using both representation spaces (e.g., range-Doppler and beamformer representations) simultaneously.

In some embodiments, FFT may be used as a beamformer. However, alternative beamformers can also be used, or be included in, some embodiments of the invention. For example, in some embodiments, the constraints introduced in the loss function as [symbol] _{bf} can be created by applying a super-resolution algorithm such as MUSIC. By combining embodiments of the invention as described with other super-resolution methods, it may be possible to achieve higher improvement factors than previously achieved by known or current systems and methods.

Experiments were performed with some embodiments of the invention and with a configuration of four input receiving channels and twelve label receiving channels and, as described, showed a 4× improved angular resolution factor. However, other configurations and/or additional permutations are also possible in embodiments of the invention. For example, eight input receiving channels and eight label receiving channels would have created a 2× improved angular resolution factor. Furthermore, given a larger original RADAR array, some embodiments of the invention can achieve larger improvement factors. For example, an array with 64 receiving channels can be split into eight input receiving channels and 56 label receiving channels which will result in a 8× improved resolution factor.

An interesting observation is shown FIG. 7B, which demonstrates a case where the RADAR is stationary, as is evident by the Doppler plot centered around v=0 m/s. In such cases, similar qualitative results arise in comparison to cases where the RADAR is moving, which suggests that, in contrast to known systems and methods, a DNN or ML module trained as described according to some embodiments of the invention does not rely exclusively on the Doppler and micro-Doppler effects during a prediction or reconstruction process.

It is noted that some embodiments of the invention can be used with different types of configuration, e.g., a configuration referred to herein as ‘sparse array’ configuration to simulate a sparse RADAR array. For example, in a ‘sparse array’ configuration the distance between each virtual antenna element may be larger than λ/2, which is optimal in terms of grating lobes and spatial ambiguity. The ‘sparse array’ configuration allows the array to have a larger, increased aperture size, thus improving its angular resolution. It is noted that such enlarged element distance may cause degraded performance in the element pattern of the array, which can also be seen in FIGS. 8A, 8B and 8C. which illustrate that, by using only the input receiving channels for beamforming, there is a significant reduction in SNR compared to using the entire array.

As described, using some embodiments of the invention, coherent artificial receiving channels may be predicted (generated and/or provided as output) to fill in the gaps. Accordingly, some embodiments of the invention provide, or enable having, a larger aperture while maintaining high performance, matching that of a full array.

Yet another advantage of some embodiments of the invention relates to mitigation, e.g., in cases of corrupted receiving channels. As described, some embodiments of the invention may be trained, and used for, predicting one or more randomly corrupted or masked channels in a set, as described, predicting and/or generating data of or for missing or corrupted channels may be based on information in the remaining (other) channels in the set. For example, ML module 230 may be trained and used as described. Accordingly, during inference, a missing receiving channel (that may be predicted, reconstructed or provided) can be any one or more receiving channels in an array. It is noted that, in order to predict, generate, reconstruct or provide a missing or corrupt channel, some embodiments of the invention do not require any configuration change, nor do some embodiments of the invention need to be notified which receiving channel is missing or corrupt. For example, an embodiment may recognize which receiving channel is missing and may predict, generate and or provide the appropriated artificial receiving channel.

As described, some embodiments of the invention offer an alternative approach to conventional, known in the art, RADAR beamforming and super resolution. Some embodiments of the invention challenge an industry and academic trend towards increasing physical channels number in RADAR arrays in order to achieve high angular resolution. As described, some embodiments use a DNN trained in a self-supervised method with a diluted antenna array to super-resolve a RADAR by coherently predicting the amplitude and phase of receiving channels outside of the physical or virtual aperture using a novel loss function in multiple data representation spaces.

Experiments with some embodiments of the invention demonstrated robust, real time performance and an improvement factor of 4× in cluttered scenarios by using a real-world dataset collected in urban and highway environments. Such improvements and advantages cannot be realized by known or current systems and methods. In addition and as described, some embodiments of the invention can be used for mitigation of hardware failure which can further increase the reliability of automotive RADARs. Accordingly, some embodiments of the invention can be combined with, or even replace, traditional, known or current systems and methods for RADAR super-resolution in real-world applications. For example, self-supervised learning as described can be used for various systems that include RADAR signal processing.

Moreover, contrary to current or known systems and methods, some embodiments of the invention do not require sparsity in the range-Doppler-azimuth dimensions. Furthermore, some embodiments of the invention can be used in highly cluttered environments such as crowded urban streets with numerous objects and targets present in the RADAR's FOV. Accordingly, some embodiments of the invention provide and enable improvements and advantages to the field of radar technology, specifically to the technological filed of autonomous vehicles.

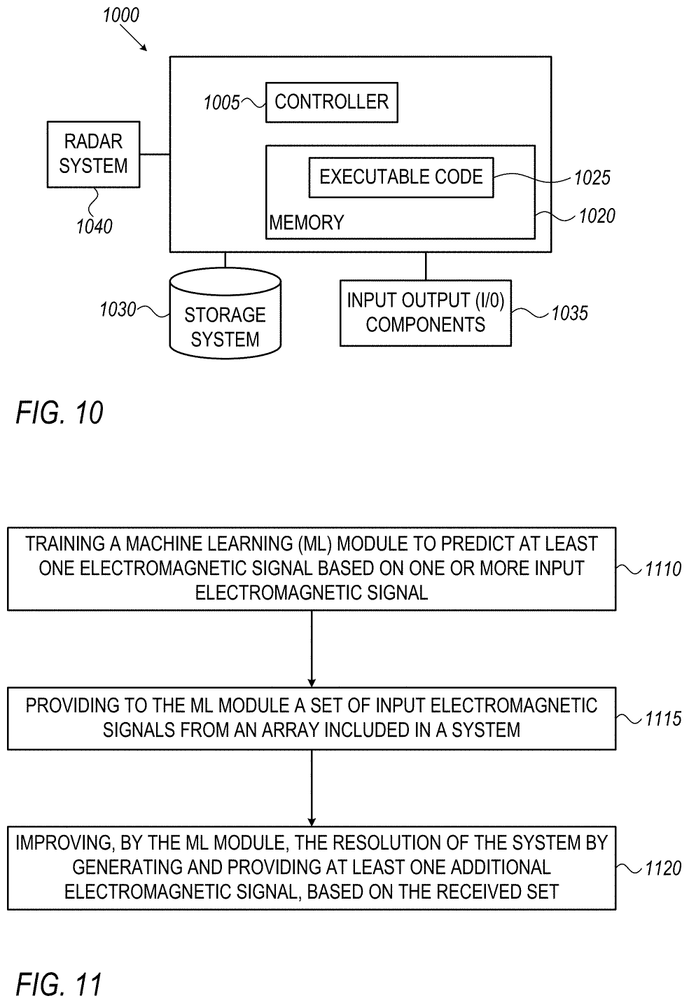

Reference is made to FIG. 10, showing a non-limiting, block diagram of a computing device or system 1000 that may be used to improve or increase a resolution of a radar system according to some embodiments of the present invention. Computing device 1000 may include a controller 1005 that may be a hardware controller. For example, computer hardware processor or hardware controller 1005 may be, or may include, a central processing unit processor (CPU), a chip or any suitable computing or computational device. Computing system 1000 may include a memory 1020, executable code 1025, a storage system 1030 and input/output (I/O) components 1035. Computing system 1000 may include, or may be, operatively connected to a radar system 1040. Radar system may include an array of antennas and/or transmitters and/or receivers and may be adapted to provide radar data. For example, radar system 1040 may be adapted to provide input channels 210 and/or input channels 440 and/or input channels 520 as described herein.

Controller 1005 (or one or more controllers or processors, possibly across multiple units or devices) may be configured (e.g., by executing software or code) to carry out methods described herein, and/or to execute or act as the various modules, units, etc., for example by executing software or by using dedicated circuitry. More than one computing device 1000 may be included in, and one or more computing devices 1000 may be, or act as the components of, a system according to some embodiments of the invention.

Memory 1020 may be a hardware memory. For example, memory 1020 may be, or may include machine-readable media for storing software e.g., a Random-Access Memory (RAM), a read only memory (ROM), a memory chip, a Flash memory, a volatile and/or non-volatile memory, a cache memory, a buffer, a short term memory unit, a long term memory unit, or any other suitable memory units or storage units. Memory 1020 may be or may include a plurality of possibly different memory units. Memory 1020 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

As referred to herein, “a controller” or “a processor” carrying out a function or set of functions can include one or more such controllers or processors, possibly in different computers, doing so. Accordingly, it will be understood that any function or operation described as performed by a controller 1005 may be carried by a set of two or more controllers in possibly respectively two or more computing devices. For example, in an embodiment, when the instructions stored in one or more memories 1020 are executed by one or more controllers 1005 they cause the one or more controllers 1005 to carry out methods of increasing and/or improving the resolution of a radar system as described herein.

Executable code 1025 may be an application, a program, a process, task or script. A program, application or software as referred to herein may be any type of instructions, e.g., firmware, middleware, microcode, hardware description language etc. that, when executed by one or more hardware processors or controllers 1005, cause a processing system or device (e.g., system 1000) to perform the various functions described herein.

Executable code 1025 may be executed by controller 1005 possibly under control of an operating system. For example, executable code 1025 may be an application, e.g., including a Machine Learning (ML) module that improves (e.g., increases) a resolution of a radar system as further described herein. Although, for the sake of clarity, a single item of executable code 1025 is shown in FIG. 10, a system according to some embodiments of the invention may include a plurality of executable code segments similar to executable code 1025 that may be loaded into memory 1020 and cause controller 1005 to carry out methods described herein.

Computing device or system 1000 may include an operating system (OS) that may be code (e.g., one similar to executable code 1025 described herein) designed and/or configured to perform tasks involving coordination, scheduling, arbitration, supervising, controlling or otherwise managing operation of computing device 1000, for example, scheduling execution of software programs or enabling software programs or other modules or units to communicate. Operating system 115 may be a commercial operating system. Accordingly, units included in computing device or system 1000 may cooperate, work together, share information and/or otherwise communicate.

Storage system 1030 may be or may include, for example, a flash memory, a disk, a universal serial bus (USB) device or other suitable removable and/or fixed storage unit.

In some embodiments, some of the components shown in FIG. 10 may be omitted. For example, memory 1020 may be a non-volatile memory having the storage capacity of storage system 1030. Accordingly, although shown as a separate component, storage system 1030 may be embedded or included in system 1000, e.g., in memory 1020.

I/O components 1035 may be, may be used for connecting, or may include: a mouse; a keyboard; a touch screen or pad or any suitable input device. I/O components may include one or more screens, touchscreens, displays or monitors, speakers and/or any other suitable output devices. Any applicable I/O components may be connected to computing device 1000 as shown by I/O components 1035, for example, a wired or wireless network interface card (NIC), a universal serial bus (USB) device or an external hard drive may be included in I/O components 1035. I/O components 1035 may be used for connecting components, e.g., connecting a first computing device 1000, chip or circuit with a second computing device 1000, chip or circuit.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, e.g., in order to train a module as described, a system may include or may be, for example, a workstation, a server computer, a network device, or any other suitable computing device.

In order to improve a resolution of a system, some embodiments may include training an ML module to predict at least one electromagnetic signal based on input electromagnetic signal; and using the ML module to improve a resolution of the system by: providing to the ML module an input set of electromagnetic signals from an array (e.g., an antenna array) included in the system; and increasing, by the ML module, the resolution of the system by generating and providing at least one additional electromagnetic signal, based on the received set.

For example, radar system 1040 may include an antenna array and, as shown by FIG. 2B, may provide ML module 230 with input electromagnetic signals as shown by input channels 210, and ML module 230 may improve a resolution of a system by generating and providing predicted channels 240, thus raising the number of channels usable by a system from four to 16.

Some embodiments may artificially increase a system's aperture size by predicting electromagnetic signals outside of an array included in the system. For example, as shown by FIG. 2B, a system's real, actual or physical aperture size (e.g., an aperture size of radar system 1040) may be determined based on a RADAR array included in the system, e.g., the four input channels 210 may reflect an aperture size radar system 1040. As described, and illustrated in FIG. 2B, ML module 230 may predict, generate and provide predicted channels 240 of electromagnetic signals which are outside (located beyond the edges of) the array included in the system, and, thus, by placing arrays of predicted channels 240 outside the array of input channels 210, an extended output array 250 is created where the aperture of output array 250 is larger than that of the aperture of the array of input channels 210.

In some embodiments, the input electromagnetic signals (e.g., input electromagnetic signals in input channels 260) may be received from a MIMO radar array as described. As further described, at least one additional electromagnetic signal may be predicted and provided, e.g., by ML module 230, such that the predicted electromagnetic signal is, or represents a component which is, outside a physical or virtual aperture of the MIMO radar array.

For example, input channels 260 may be received from (and, therefore, represent) an actual, physical radar or antenna array including 16 antennas distributed over a given space. Accordingly, array 270 (including channels 241, which are outside array 260) may represent an actual, physical radar or antenna array including 32 antennas distributed over a space which is twice the given space, thus, for example, increasing or enlarging an aperture's size.

Some embodiments may train an ML module to increase, and use the ML module for increasing, resiliency of a system by replacing at least one electromagnetic signal with an artificially generated electromagnetic signal. For example, upon detecting or determining that an electromagnetic signal is corrupted, e.g., identifying, determining or being informed that data received over a channel as described is corrupted, ML module 230 may replace an electromagnetic signal (e.g., the relevant channel) with a predicted or generated electromagnetic signal, e.g., a predicted channel as described. Any system, method or technique may be used in order to identify or determine that data received over a channel is corrupted. For example, ML module 230 may be trained to identify or determine that data received from a channel is corrupted. In some embodiments, a unit adapted and/or dedicated to identifying corrupted data in channels may, upon determining a channel is corrupted, block or mask the channel which may cause ML module 230 to predict and generate the blocked (and corrupted) channel.

For example, as shown by FIGS. 5A and 5B and described herein, ML module 230 may be trained to replace one or more missing channels in the set of input channels 520. For example, the set of channels 520 may be provided by, or based on input from, an array of antennas in radar system 1040 and may thus include electromagnetic signals or digital representations of electromagnetic signals. Accordingly, e.g., at inference, a trained as described ML module 230 may replace a missing channel. It will be noted that any system, method or technique may be used in order to determine, identify or detect that a channel is missing, corrupt or is otherwise inadequate or unusable. Accordingly, some embodiments of the invention may increase the resiliency of a system, e.g., in case of a faulty unit (e.g., a faulty antenna or receiver), ML module 230 can predict, reconstruct and provide the relevant channel that would otherwise be missing.

In some embodiments, an ML module may be trained using an unsupervised training, the unsupervised training may include: randomly removing one or more electromagnetic signals from an input set of electromagnetic signals; and training the ML module to predict the removed electromagnetic signal. For example, as shown by FIGS. 5A and 5B and described herein, training ML module 230 may include randomly selecting to mask or block one or more of input channels 520 (which, as described, may be, or may include, an electromagnetic signal), or otherwise prevent one of input channels 520 from reaching, or being provided to, ML module 230. By executing a large enough number of iterations in which one of input channels 520 is randomly selected, masked or blocked (and used as label data), ML module 230 may be trained to reconstruct, predict, generate and/or provide any missing channel. Training ML module 230 may include randomly selecting to mask or block two or more of input channels 520. ML module 230 may be trained to reconstruct, predict, generate and/or provide any number or set of channels which are missing or corrupted at the same time.

In some embodiments, training an ML module may be an unsupervised training including: removing one or more electromagnetic signals from an input set of electromagnetic signals; and training the ML module to predict the removed electromagnetic signal based on other electromagnetic signals in the input set. For example, an automated process may include repeating the steps of: selecting to block, or mask from ML module 230, one of input channels 520 (e.g., channel 510), causing ML module 230 to predict the blocked or masked channel, evaluating the prediction using the blocked channel as label data, and modifying parameters of ML module 230 according to the evaluation. Such automated process may include any (typically very large) number of iterations as described and may thus be unsupervised, that is, the described training process can be carried out without any intervention of a user.

In some embodiments, an ML module may be trained (and used in order) to generate an electromagnetic signal based on at least one of: an amplitude and phase of at least one electromagnetic signal included in a set of input electromagnetic signal. For example and as described, ML module may be trained, and used for, generating predicted channels 240 based on amplitudes and/or phases of one or more electromagnetic signals in input channels 210, or in another example, predict, generate and/or provide channel 530 based on amplitudes and/or phases of one or more electromagnetic signals in input channels 520.

In some embodiments, an ML module may be trained (and used in order) to predict, generate and/or provide electromagnetic signal such that at least one of: an amplitude and phase of the predicted, generated and/or provided electromagnetic signal is coherent with an amplitude and phase of at least some electromagnetic signals included in a set of input electromagnetic signals. For example and as described, ML module 230 may be trained, and used for, generating predicting and/or providing channel 530 (e.g., provide an electromagnetic signal included in channel 530) such that at least one of an amplitude and phase of the generated electromagnetic signal in channel 530 is coherent with the amplitudes and/or phases of one or more electromagnetic signals included (or represented by) input channels 520.

As described, an electromagnetic signal (or a channel) as referred to herein may include information related to at least one of: range, Doppler, azimuth and elevation.

In some embodiments, a method may include: training an ML module to predict at least one electromagnetic signal based on other electromagnetic signals; receiving, by the ML module, an input set of electromagnetic signal from an array included in a system (e.g., an antenna array in radar system 1040); and by interpolation, generating, by the ML module, at least one additional electromagnetic signal to thus achieve at least one of: higher Signal to Noise Ratio SNR and smaller grating lobes. For example and as illustrated in FIG. 4B, artificial (predicted) receiving channels 450 are, by interpolation, inserted between (an array of four) input receiving channels 440 such that the resulting array 460 includes sixteen channels thus enabling higher SNR and smaller grating lobes as described.

In some embodiments, an ML module may be adapted (trained or used) to artificially increase or enlarge an aperture of a system by extrapolating electromagnetic signal outside of an array's aperture. For example, as illustrated in FIG. 2B, predicted channels 240 may be generated based on extrapolation applied to input channels 210 and may accordingly be placed outside the array of input channels 210 thus extending, increasing or enlarging the aperture of a system.

As described, some embodiments may predict, generate and provide channels using interpolation and using extrapolation, it will be understood that some embodiments may concurrently, simultaneously or at the same time, predict, generate and provide a number of channels where some of the provided channels are generated or predicted by, or using interpolation and some of the channels are generated or predicted by, or using extrapolation. For example, ML module 230 may, concurrently, simultaneously or at the same time, predict, generate and provide some of predicted channels 240 by, or using, extrapolation and predict, generate and provide artificial (predicted) receiving channels 450 by, or using interpolation.

A system according to some embodiments may include an antenna array; and an ML module adapted to: receive an input set of electromagnetic signals from the array; and improve the resolution of the system by generating and providing at least one additional electromagnetic signal based on the received input set. For example, ML module 230 may be, may include or may be implemented using computing system 1000 which may receive electromagnetic signals from radar system 1040, e.g., in the form of channels 440. For example, (e.g., by executing ML module 230) controller 1005 may receive an input set of electromagnetic signals from radar system 1040 (e.g., in the form of channels as described) and may generate and provide at least one additional electromagnetic signal (e.g., in the form of additional channels 450 as described) based on the received input set.

Reference is made to FIG. 11, which shows a flowchart of a method according to illustrative embodiments of the present invention. As shown by block 1110, an ML module may be trained to predict at least one electromagnetic signal based on one or more input electromagnetic signal. For example, ML module 230 may be trained to predict channel 250 based on channels in input 520 as described. As shown by block 1115, the ML module may be provided with a set of input electromagnetic signals from an array included in a system. For example, ML module 230 may be provided with a set of input electromagnetic signals (e.g., represented by data in channels 440 received from radar system 1040). As shown by block 1120, the ML module may improve the resolution of the system by generating and providing at least one additional electromagnetic signal based on the provided set of input electromagnetic signals. For example, ML module 230 may generate and provide (e.g., in the form of predicted channels 240 or 241) additional electromagnetic signals.

In the description and claims of the present application, each of the verbs, “comprise” “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of improving a resolution of a system, the method comprising:
training a Machine Learning (ML) module to predict at least one electromagnetic signal based on at least one input electromagnetic signal; and
using the ML module to improve a resolution of the system by:
providing to the ML module a first set of input electromagnetic signals from an array included in the system; and
improving, by the ML module, the resolution of the system by generating and providing at least one additional electromagnetic signal, based on the first set of input electromagnetic signals.

2. The method of claim 1, further comprising training the ML module to artificially increase a size of an aperture by predicting an electromagnetic signal outside of the aperture.

3. The method of claim 1, wherein the input electromagnetic signals are received from a Multiple In Multiple Out (MIMO) radar array, and wherein the at least one additional electromagnetic signal is outside the physical or virtual aperture of the MIMO radar array.

4. The method of claim 1, further comprising training the ML module to increase, and using the ML module for increasing, resiliency of the system by replacing at least one electromagnetic signal which includes corrupted data with an artificially generated electromagnetic signal.

5. The method of claim 1, wherein the step of training the ML module is an unsupervised training including:
randomly removing one or more electromagnetic signals from an input set of electromagnetic signals; and
training the ML module to predict the removed electromagnetic signal.

6. The method of claim 1, wherein training the ML module is an unsupervised training including:
removing one or more electromagnetic signals from an input set of electromagnetic signals; and
training the ML module to predict the removed electromagnetic signal based on other electromagnetic signals included in the input set.

7. The method of claim 1, wherein the ML module is trained to generate an electromagnetic signal based on at least one of: an amplitude and phase of at least one electromagnetic signal included in a set of input electromagnetic signals.

8. The method of claim 7, wherein the ML module is trained to predict an electromagnetic signal such that at least one of: an amplitude and phase of the predicted electromagnetic signal is coherent with an amplitude and phase of at least some electromagnetic signals included in a set of input electromagnetic signals.

9. The method of claim 1, wherein an electromagnetic signal includes information related to at least one of: range, Doppler, azimuth and elevation.

10. A method, the method comprising:
training a Machine Learning (ML) module to predict at least one electromagnetic signal based on other electromagnetic signals;
receiving, by the ML module, a set of input electromagnetic signals from an array included in a system; and
by interpolation, generating, by the ML module, at least one additional electromagnetic signal to thus achieve at least one of: higher Signal to Noise Ratio (SNR) and smaller grating lobes.

11. The method of claim 9, further comprising training the ML module to, and using the ML module for, increasing resiliency of the system by replacing at least one of the electromagnetic signals in the set with an artificially generated electromagnetic signal.

12. The method of claim 9, wherein the ML module is trained to generate an electromagnetic signal based on at least one of: an amplitude and phase of at least one of the electromagnetic signals included in the set and such that at least one of: an amplitude and phase of the generated electromagnetic signal is coherent with an amplitude and phase of at least one of the electromagnetic signals included in the set.

13. A system including:
an antenna array; and
a Machine Learning (ML) module adapted to:
receive a set of input electromagnetic signals from the antenna array; and
improve the resolution of the system by generating and providing at least one additional electromagnetic signal based on the received set of input electromagnetic signals.

14. The system of claim 13, wherein the ML module is further adapted to artificially enlarge an aperture of the system by extrapolating an electromagnetic signal outside of the antenna array's aperture.

15. (canceled)

16. The system of claim 13, wherein the ML module is further adapted to increase resiliency of the system by replacing an electromagnetic signal from the set of input electromagnetic signals, which electromagnetic signal includes corrupted data, with one or more artificially generated electromagnetic signals.

17. The system of claim 13, wherein the step of training the ML module is an unsupervised training including:
randomly removing one or more electromagnetic signals from a set of input electromagnetic signals; and
training the ML module to predict the removed one or more electromagnetic signals.

18. The system of claim 13, wherein the step of training the ML module is an unsupervised training including:
removing one or more electromagnetic signals from a set of input electromagnetic signals; and
training the ML module to predict the removed one or more electromagnetic signals based on the remainder electromagnetic signals in the set.

19. The system of claim 13, wherein the ML module is trained to generate an electromagnetic signal based on at least one of: an amplitude and phase of at least one input electromagnetic signal included in the set of input electromagnetic signals.

20. The system of claim 19, wherein the ML module is trained to predict an electromagnetic signal such that at least one of: an amplitude and phase of the predicted an electromagnetic signal is coherent with an amplitude and phase of at least some electromagnetic signals included in the set of input electromagnetic signals.

21. The system of claim 13, wherein an electromagnetic signal includes information related to at least one of: range, Doppler, azimuth and elevation.
